(19) United States
(12) Patent Application Publication
(10) Pub. No.: US 2014/0120270 A1
(43) Pub. Date: May 1, 2014

(54) DIRECT GROWTH OF GRAPHENE FILMS ON NON-CATALYST SURFACES

(71) Applicants: James M. Tour, Bellaire, TX (US); Zheng Yan, Houston, TX (US); Zhiwei Peng, Houston, TX (US); Zhengzong Sun, Shanghai (CN)

(72) Inventors: James M. Tour, Bellaire, TX (US); Zheng Yan, Houston, TX (US); Zhiwei Peng, Houston, TX (US); Zhengzong Sun, Shanghai (CN)

(21) Appl. No.: 14/113,856

(22) PCT Filed: Sep. 9, 2011
(86) PCT No.: PCT/US11/51016

§ 371 Date: Jan. 13, 2014

Related U.S. Application Data
(60) Provisional application No. 61/478,672, filed on Apr. 25, 2011.

(51) Int. Cl. C01B 31/04

(52) U.S. Cl. CPC C01B 31/0453
USPC 427/596; 427/122

(57) ABSTRACT

The present invention provides methods of forming graphene films on various non-catalyst surfaces by applying a carbon source and a catalyst to the surface and initiating graphene film formation. In some embodiments, graphene film formation may be initiated by induction heating. In some embodiments, the carbon source is applied to the non-catalyst surface before the catalyst is applied to the surface. In other embodiments, the catalyst is applied to the non-catalyst surface before the carbon source is applied to the surface. In further embodiments, the catalyst and the carbon source are applied to the non-catalyst surface at the same time. Further embodiments of the present invention may also include a step of separating the catalyst from the formed graphene film, such as by acid etching.

### CROSS REFERENCE TO RELATED APPLICATIONS

This application claims priority to U.S. Provisional Patent Application No. 61/478,672, filed on Apr. 25, 2011. The entirety of the above-referenced provisional application is incorporated herein by reference.

### STATEMENT REGARDING FEDERALLY SPONSORED RESEARCH

This invention was made with government support under the Office of Naval Research Grant No. N00014-09-1-1066, awarded by the U.S. Department of Defense; and the Air Force Office of Scientific Research Grant No. FA9550-09-1-0581, also awarded by the U.S. Department of Defense. The government has certain rights in the invention.

### BACKGROUND OF THE INVENTION

Graphene films find many applications in various fields. Current methods to form graphene films suffer from various limitations. Therefore, there is currently a need to develop more optimal methods of forming graphene films.

### BRIEF SUMMARY OF THE INVENTION

In some embodiments, the present invention provides methods of forming a graphene film directly on a desired non-catalyst surface by applying a carbon source and a catalyst to the surface and initiating the formation of the graphene film. Further embodiments of the present invention may also include a step of separating the catalyst from the formed graphene film, such as by acid etching.

In some embodiments, the catalyst may be applied to the non-catalyst surface before the carbon source is applied to the surface. In some embodiments, the carbon source may be applied to the non-catalyst surface before the catalyst is applied to the surface. In some embodiments, the carbon source and the catalyst are applied to the non-catalyst surface at the same time.

In some embodiments, the non-catalyst surface is a non-metal substrate or an insulating substrate. In some embodiments, the non-catalyst surface is selected from the group consisting of silicon (Si), silicon oxide (SiO₂), SiO₂/Si, silicon nitride (Si₃N₄), hexagonal boron nitride (h-BN), sapphire (Al₂O₃), and combinations thereof.

In some embodiments, the carbon source is selected from the group consisting of polymers, self-assembly carbon monolayers, organic compounds, non-polymeric carbon sources, non-gaseous carbon sources, gaseous carbon sources, and combinations thereof. In some embodiments, the carbon source includes a nitrogen-doped carbon source. In some embodiments, the methods of the present invention may also include a separate nitrogen-doping step.

In some embodiments, the catalyst is a metal catalyst. The metal catalyst may be selected from the group consisting of Ni, Co, Fe, Pt, Au, Al, Cr, Cu, Mg, Mn, Mo, Rh, Si, Ta, Ti, W, U, V, Zr and combinations thereof.

In some embodiments, the step of initiating the formation of a graphene film comprises induction heating. In some embodiments, the graphene film is formed in the presence of a continuous flow of an inert gas, such as H₂, N₂, Ar, and combinations thereof. In some embodiments, the graphene film is formed at a temperature range between about 800° C. and about 1100° C. In some embodiments, formed graphene film comprises a single layer. In some embodiments, the formed graphene film comprises a plurality of layers, such as a bilayer.

As set forth in more detail below, the methods of the present invention provide numerous advantages, including the direct formation of homogenous graphene films on a desired surface without the need for a transfer step. As also set forth in more detail below, the graphene films formed by the methods of the present invention can find numerous applications in various fields.

### BRIEF DESCRIPTION OF THE FIGURES

FIG. 1 provides various schemes for growing graphene films on various surfaces. FIG. 1A illustrates a graphene film formation method where a carbon source is first applied to a surface (in this case, an insulating substrate). This is followed by the application of a metal catalyst to the carbon source to form the graphene film on the surface. FIG. 1B illustrates a graphene film formation method where a metal catalyst (in this case, Ni) is first applied to a surface (in this case, an insulating substrate). This is followed by the application of a carbon source (in this case, a polymer) to the catalyst to form a graphene film on the surface. FIG. 1C shows Raman spectra of graphene films formed in accordance with the method illustrated in FIG. 1B. The left panel is a Raman spectrum of the few-layer graphene formed on the top of the Ni metal catalyst. The right panel is a Raman spectrum of bilayer graphene formed on the top of the surface after etching (right panel).

FIG. 2 shows an apparatus for forming graphene films, in accordance various embodiments of the present invention.

FIG. 3 illustrates the formation and spectroscopic analysis of bilayer graphene. FIG. 3A shows a scheme where bilayer graphene is derived from polymers or self-assembly monolayers (SAMs) on SiO₂/Si substrates by annealing the sample in an H₂/Ar atmosphere at 1,000° C. for 15 min. FIG. 3B shows a Raman spectrum (514 nm excitation) of bilayer graphene derived from poly(2-phenylpropyl)methysiloxane (PPMS). FIG. 3C shows bilayered 2D peaks were split into four components: 2D_{1B}, 2D_{1A}, 2D_{2A}, 2D_{2B} (yellow peaks, from left to right). FIGS. 3D-3E show two-dimensional Raman (514 nm) mapping of the bilayer graphene film (112×112 μm²). The color gradient bar to the right of each map represents the D/G peak ratio (FIG. 3D) or G/2D peak ratio (FIG. 3E) showing ˜90% bilayer coverage. The scale bars in d and e are 20 μm.

FIG. 4 shows transmission electron microscopy (TEM) analysis of PPMS-derived bilayer graphene. FIGS. 4A-4B show low-resolution TEM images showing bilayer graphene films suspended on a TEM grid. FIG. 4C shows hexagonal selected area electron diffraction (SAED) pattern of the bilayer graphene with a rotation in stacking of 5° between the two layers. FIG. 4D shows a high resolution transmission electron microscopy (HRTEM) picture of PPMS-derived graphene edges. The PPMS-derived graphene was 2 layers thick at random exposed edges.

FIG. 5 shows the electrical properties of PPMS-derived graphene and spectroscopic analysis of graphene from different carbon sources and different substrates. FIG. 5A shows room temperature I_{DS}-V_{G} curve from a PPMS-derived bilayer graphene-based back-gated field effect transistor (FET) device. I_{DS}, drain-source current; V_{G}, gate voltage; V_{DS}, drain-source voltage. FIG. 5B shows the difference in Raman spectra from PMMS-derived bilayer graphene samples prepared from different thicknesses of the starting PPMS film. FIG. 5C shows Raman spectra of graphene derived from polystyrene (PS), poly(methyl methacrylate) (PMMA), acrylonitrile butadiene styrene (ABS) and SAM made from butyltriethoxysilane. FIG. 5D shows Raman spectra of graphene derived from PPMS on hexagonal boron nitride (h-BN), silicon nitride (Si₃N₄) and sapphire (Al₂O₃). The baseline has been subtracted from the Raman spectrum of graphene synthesized on h-BN (see FIG. 10 for the original data).

FIG. 6 shows Raman spectra of graphene derived from different carbon sources. FIG. 6A shows Raman spectra of graphene derived from PPMS. In PPMS-derived graphene, single-layer, bilayer and few-layer regions were all recorded by Raman spectroscopy. According to the Raman mapping shown in FIG. 3E, the bilayer region has the largest coverage (i.e., around 90%). FIG. 6B shows Raman spectra of graphene derived from PMMA. Monolayer, bilayer and few-layer graphene can all be found in PMMA-derived graphene films, as recognized by the spectra. FIG. 6C shows a Raman spectrum of a control sample with no carbon source. No graphene peaks were observed after annealing at high temperature and etching away the nickel layer.

FIG. 7 shows hexagonal SAED pattern of Bernal stacked graphene. The diffraction analysis shows that a small portion (3-5%) appears to be Bernal (AB) stacked graphene.

FIG. 8 shows photographs of PPMS-derived graphene and the base silicon oxide (SiO₂). The photographs show that a full chip-scale graphene film was grown on SiO₂. A ruler with cm divisions is shown below the structures.

FIG. 9 shows the scheme and SEM image for a PPMS-derived bilayer graphene-based device. FIG. 9A shows a schematic of the graphene device. FIG. 9B shows the SEM images of the as-made device (the scale bar is 10 μm).

FIG. 10 shows the Raman spectra of h-BN and Graphene/h-BN. The bottom curve is the Raman spectrum of the h-BN substrate before the graphene growth. The top curve is the Raman spectrum of graphene synthesized directly on the h-BN substrate.

FIG. 11 shows the scheme for the proposed growth mechanism of PPMS-derived bilayer graphene. The PPMS film decomposed and dissolved into the Ni film during the annealing process (1000° C.). When the sample was removed from the hot-zone of the furnace and cooled to room temperature, the part of that carbon that dissolved in the bulk metal precipitated from both sides of the Ni to form graphene on both the top and the bottom of the Ni layer.

FIG. 12 shows Raman spectra analysis (514 nm) of PPMS-derived graphene. FIG. 12A shows a schematic for forming the PMMS-derived graphene by annealing Ni/PPMS/SiO₂/Si at 1000° C. with H₂/Ar for 15 minutes. FIG. 12B shows a Raman spectrum of the top surface of Ni. The spectrum suggests that graphene was also grown on the top surface. FIG. 12C shows a Raman spectrum of the top surface of Ni after placing the sample in UV-ozone for 15 min. The spectrum suggests that graphene on the top surface of Ni was damaged as a result of the UV exposure. FIG. 12D shows a Raman spectrum of the top surface of the SiO₂/Si substrate after the Ni was removed by an etchant. The results suggest that high-quality bilayer graphene was still obtained on the SiO₂/Si substrate after etching.

FIG. 13 shows Raman spectra analysis of PPMS-derived bilayer graphene. FIG. 13A shows bilayer graphene grown on a SiO₂/Si substrate at 950° C. FIG. 13B shows bilayer graphene grown on a SiO₂/Si substrate at 1080° C.

FIG. 14 shows Raman spectral analysis of graphene synthesized using copper as the catalyst. FIG. 14A shows that amorphous carbon was produced rather than graphene when a 4-nm PPMS film was deposited on SiO₂/Si, and the PPMS film was capped with a layer of copper (500 nm thick). FIG. 14B shows that a few-layer graphene was obtained when the SAM-derived from butyltriethoxysilane was used as the carbon source, and the SAM was capped with copper and subjected to the same reaction conditions as in FIG. 14A.

FIG. 15 shows x-ray photo-electron spectroscopy (XPS) analysis of ABS-derived graphene. FIG. 15A indicates that the N1s peaks in ABS-derived graphene correspond to two types of N: pyridinic N (398.8 eV) and quaternary N (401.1 eV) in graphene. These N1s peaks have clear shifts from that of nitrile (RCN) (399.1 eV) in ABS (˜3% N content), as shown in FIG. 15B. FIG. 15C shows a second XPS analysis of ABS-derived graphene. The N1s peaks in ABS-derived graphene can be deconvoluted into 2 small peaks at 399.6 eV and 401.2 eV, corresponding to pyridinic N and quaternary N, respectively. Based on a high resolution XPS (HRXPS) analysis, the N content is about 2.9% in the ABS-derived graphene film. The results suggest that the N1s signals do come from N-doped graphene instead of ABS.

FIG. 16A shows Raman spectra of graphene obtained at different growth temperatures using PMMA as the top carbon source. FIG. 16B shows the scheme used to obtain the graphene where the polymer layer was applied to the top face of the catalysts, and graphene formed on both sides.

FIG. 17A shows Raman spectra of ABS-derived bilayer graphene on SiO₂. FIG. 17B shows the N1s peaks in ABS-derived bilayer graphene. FIG. 17C shows the scheme used to obtain the graphene.

FIG. 18 illustrates the growth of bilayer graphene from gaseous carbon sources. FIG. 18A shows a schematic for growing bilayer graphene from a gaseous carbon source. A layer of Ni is thermally evaporated on a SiO₂ substrate. This is followed by chemical vapor deposition (CVD) growth at 1000° C. in H₂:CH₄ (400:60 sccm) atmosphere under ambient pressure. After etching away the Ni, bilayer graphene is obtained on the substrate. FIG. 18B shows a Raman spectrum of graphene formed by the Ni-catalyzed CVD method illustrated in FIG. 18A. The spectral analysis covered the graphene that formed underneath the Ni layer (after removing the Ni).

FIG. 19 shows a TEM analysis of CVD-derived bilayer graphene. FIG. 19A shows a hexagonal SAED pattern of the bilayer graphene that shows a small rotation angle of ˜6° between the two layers. FIGS. 19B-19C show HRTEM images of bilayer graphene edges that represent 2 carbon layers.

FIG. 20 shows Raman spectra of bilayer graphene from CVD growth at different CH₄ flow rates. With a CH₄ flow rate lower than 40 sccm, a high D peak is shown. If the CH₄ flow rate is larger than 60 sccm, the D peak is minimized. Based on the G/2D peak ratios, the peak positions and FWHM of the 2D peak, the results indicate that the obtained graphene films are bilayer.

FIG. 21 show the Raman mapping of bilayer graphene derived from high impact polystyrene (HIPS). FIG. 21A shows Raman mapping of the bilayer graphene film G/2D peak ratio (100×100 μm²). FIG. 21B shows Raman mapping of the D/G peak ratio. FIG. 21C shows Raman mapping of the FWHM. Six out of 121 data points have a D/G peak ratio larger than 0.10. Bilayer coverage is ˜80%. The scale bar is 20 μm in all three panels.

### DETAILED DESCRIPTION OF EXEMPLARY EMBODIMENTS

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes only and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Graphene has garnered enormous interest among physicists, chemists and material scientists since its first isolation in 2004. In particular, the discovery of the tunable band gap in bilayer graphene opens the pathway for its applications in graphene-based electronics and optics. For such applications, uniform-thickness and large-size growth of graphene on insulating substrates is desirable.

Currently, there are mainly four ways that can produce graphene on insulating substrates. The original mechanical peeling method can yield isolated and high-quality graphene crystals. However, the size of this graphene crystal is only within a 10 μm range. Furthermore, this method does not fit the industrial production process.

The assembly of reduced graphene oxide can produce low-cost and large-size graphene films. However, the obtained films demonstrate relatively poor electrical properties. Epitaxial growth on silicon carbide (SiC) can also provide large-area and high-quality multilayer graphene directly on insulating substrates. However, it is hard to make electrically isolated mono- or bilayer graphene by this method. Moreover, the relatively high cost of SiC substrates, and the growth requirements for high temperature (˜1450° C.) and ultra high vacuum (UHV; base pressure 1×10⁻¹⁰ Torr) have limited the application of the above-mentioned methods.

Chemical vapor deposition (CVD) can also be used to synthesize large-size and high-quality graphene with controlled layers on metal substrates. Yet, in this method, graphene needs to be separated from metal substrates first, and then transferred to other substrates or surfaces (e.g., insulating substrates) for further processing.

Accordingly, Applicants have developed novel methods of forming graphene films. Such methods generally involve growing a graphene film directly on a desired non-catalyst surface by applying a carbon source and a catalyst to the surface and initiating the growth of the graphene film. Further embodiments of the present invention may also include a step of separating the catalyst from the formed graphene film, such as by acid etching.

In some embodiments, the catalyst may be applied to the non-catalyst surface before the carbon source is applied to the surface. In such cases, the catalyst may form a layer directly above the surface. The carbon source may subsequently be applied to the non-catalyst surface above the formed catalyst layer.

In some embodiments, the carbon source may be applied to the non-catalyst surface before the catalyst is applied to the surface. In such cases, the carbon source may form a layer directly above the surface. The catalyst may subsequently be applied to the non-catalyst surface above the formed carbon source layer. In some embodiments, the catalyst and the carbon source are applied to the non-catalyst surface at approximately the same time.

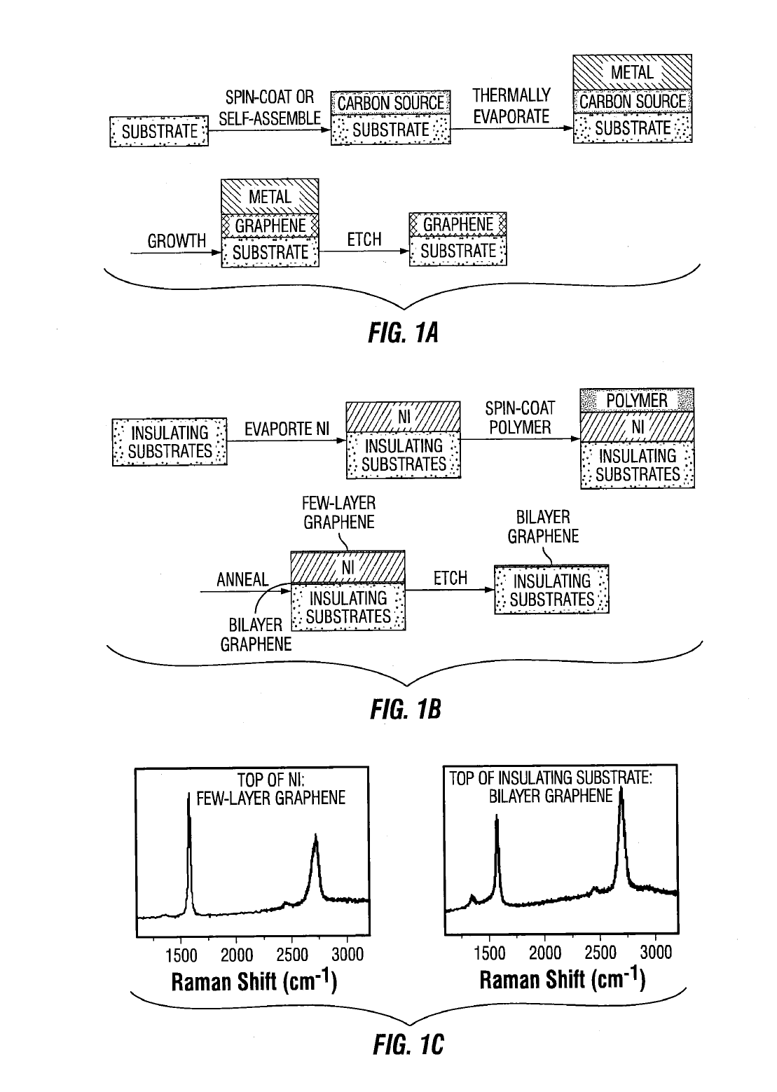

FIG. 1A illustrates a specific and non-limiting exemplary method of forming graphene films directly on a desired non-catalyst surface (in this case, an insulating substrate). In this method, a carbon source is first applied to an insulating substrate by a spin coating method to form a carbon source layer directly on top of the insulating substrate. This is followed by the application of a layer of a metal catalyst film to the carbon source by thermal evaporation (or sputtering, pressing, printing or other application methods). In some embodiments, the metal catalyst layer can also be patterned atop the carbon layer using a mask of direct writing or printing process. Thereafter, the growth of graphene film is initiated at 1000° C. under a low pressure (˜10 Torr) and a reducing atmosphere. This results in the formation of a bilayer of graphene directly on top of the insulating substrate. Next, the metal catalyst is removed by etching.

FIG. 1B illustrates another specific and non-limiting exemplary method of forming a graphene film directly on a non-catalyst surface (in this case, an insulating substrate). In this embodiment, a layer of a metal catalyst film (in this case, Ni) is applied to an insulating substrate by thermal evaporation. This is followed by the application of a carbon polymer film onto the Ni layer by a spin coating method. Thereafter, the growth of graphene film is initiated (as described above). This is followed by the removal of Ni by etching.

As shown in FIG. 1C, the method in FIG. 1B results in the formation of a bilayer graphene film directly on top of the insulating substrate. A few layer graphene was also formed on top of the Ni catalyst layer, even though it was removed by etching.

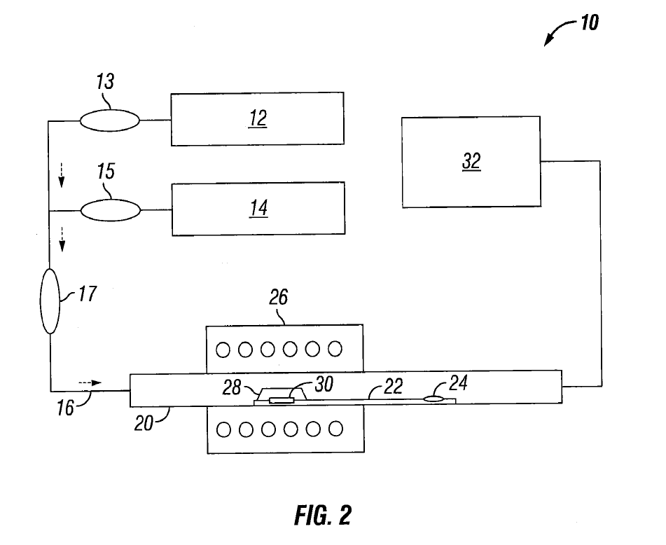

A specific and non-limiting example of an apparatus that can be used for the direct growth of graphene films on non-catalyst surfaces is shown in FIG. 2 as apparatus 10. In this embodiment, apparatus 10 consists of hydrogen chamber 12, argon chamber 14, quartz tube 20, split tube furnace 26, and rotary pump 32. The aforementioned components are connected to each other through tubing network 16.

Hydrogen chamber 12 and argon chamber 14 are also connected to filter 13 and filter 15, respectively through tubing network 16. Both chambers are also connected to filter 17 through tubing network 16, which flows into quartz tube 20.

Quartz tube 20 contains base member 22, which in turn houses magnetic rod 24 and sample 30. Sample 30 may contain a non-catalyst substrate with a surface, the carbon source and the catalyst in various arrangements. See, e.g., FIGS. 1A-1B. Sample 30 may also be covered by enclosure 28. In this embodiment, enclosure 28 is a copper enclosure that was formed by bending 25-μm-thick copper foil (Alfa Aesar, 99.98%).

In a typical operation, the pressure of quartz tube 20 is reduced to about 50 mTorr. In addition, the temperature of quartz tube 20 near split tube furnace 26 is maintained at about 1000° C. by actuating the split tube furnace. Next, rotary pump 32 is actuated to feed H₂ (20-600 sccm) and Ar (500 sccm) through tubing network 16 and into quartz tube 20. The total pressure of quartz tube 20 is maintained at about 7 Torr. Thereafter, sample 30 is placed in copper enclosure 28 in order to trap trace O₂ and carbon in the system. Magnetic rod 24 is then used to move the sample to the hot region near split tube furnace 26 (1000° C.) for about 7 to 20 minutes. Thereafter, the sample is rapidly cooled to room temperature by quickly removing it from the hot-zone of the furnace using magnetic rod 24.

Compared to existing methods, the methods of the present invention can produce high-quality and uniform graphene films (e.g., graphene bilayers) directly on desired non-catalyst surfaces (e.g., insulating substrates) without the need for a transfer step. Various aspects of the aforementioned methods of making graphene films will now be discussed in more detail below. However, Applicants note that the description below pertains to specific and non-limiting examples of how a person of ordinary skill in the art can make and use the graphene films of the present invention.

Surfaces

Graphene films may be grown on various surfaces. In some embodiments, the surface is a non-catalyst surface. As used herein, non-catalyst surfaces include surfaces that are not capable of catalytically converting substantial amounts of carbon sources to graphene films by themselves. In some embodiments, the non-catalyst surface may nonetheless have low or trace amounts of catalytic activity for converting carbon sources to graphene films.

In some embodiments, the non-catalyst surface is an insulating substrate. Insulating substrates generally refer to compositions that do not respond substantially to an electric field and may resist the flow of electric charge. In some embodiments, the insulating substrate has a bandgap greater than 1 eV.

In some embodiments, the non-catalyst surface is a semiconducting substrate. In some embodiments, the semiconducting substrate has a bandgap between 0.1 eV and 1 eV. In some embodiments, the non-catalyst surface is a non-metal substrate. In some embodiments, the non-metal substrates may still have trace amounts of metals, such as metal impurities. In some embodiments, the metal impurities may amount from about 0.001% to about 1% of the substrate content.

More specific examples of suitable non-catalyst surfaces include, without limitation, surfaces made or derived from silicon (Si), silicon oxide (SiO₂), SiO₂/Si, silicon nitride (Si₃N₄), hexagonal boron nitride (h-BN), sapphire (Al₂O₃), and combinations thereof. In some embodiments, the surface is made or derived from SiO₂/Si.

Surfaces may also be prepared or treated by various methods before exposure to carbon sources or catalysts. For instance, in some embodiments, the surfaces of the present invention may be treated or exposed to acid (e.g., sulfuric acid), oxygen (e.g., oxygen-plasma etching), oxidants (e.g., hydrogen peroxide), water (e.g., deionized water), inert gases (e.g., nitrogen), or vacuum flow. For instance, in some embodiments, a SiO₂ substrate may be treated by oxygen-plasma etching for 10 minutes followed by immersion in Piranha solution (4:1 sulfuric acid to hydrogen peroxide) at 95° C. for 30 min. The SiO₂ surfaces may also be thoroughly cleaned with deionized water and dried by nitrogen flow. Then, the substrates may be further dried in a vacuum oven at 80° C. for 30 minutes. In further embodiments, silicon nitride and sapphire may also be cleaned using the above procedure before coating carbon sources. In further embodiments, a boron nitride substrate may be made by transferring boron nitride on cleaned SiO₂/Si surfaces, as depicted in Ci et al., “Atomic Layers of Hybridized Boron Nitride and Graphene Gomains.” Nature Mater. 9, 430-435 (2010)”.

The surfaces of the present invention can also have various shapes and structures. For instance, in various embodiments, the surfaces may be circular, square-like, or rectangular. In additional embodiments, the surfaces (or the carbon sources atop the surfaces, or the catalysts atop the surfaces) can be pre-patterned. In such embodiments, the graphene film can be grown following those patterns.

The surfaces of the present invention can also have various sizes. In various embodiments, such sizes can be in the nanometer, millimeter or centimeter ranges. In some embodiments, the lateral size of the substrate could be from about 10 nm² to about 10 m². In some embodiments, the surface can be as small as 1-nanometer on a face, or as a sphere.

In other embodiments, the surface can be as large as 100 square meters on a face. However, the latter embodiments may require a large furnace (or a continuous growth furnace) for graphene film formation. For the latter embodiments, roll-to-roll films of metal could also be used as the surfaces pass though a furnace's hot-zone.

Carbon Sources

In the present invention, carbon sources generally refer to compositions that are capable of forming graphene films on various surfaces. Various carbon sources may be used to form graphene films in the present invention. For instance, in some embodiments, suitable carbon sources may include, without limitation, polymers, self-assembly carbon monolayers (SAMs), organic compounds, non-polymeric carbon sources, non-gaseous carbon sources, gaseous carbon sources, solid carbon sources, liquid carbon sources, small molecules, fullerenes, fluorenes, carbon nanotubes, phenylene ethynylenes, sucrose, sugars, polysaccharides, carbohydrates, proteins, and combinations thereof.

In a specific embodiment, the carbon source may be a self-assembly monolayer of butyltriethoxysilane or aminopropyltriethoxysilane (APTES). Additional carbon sources that can form graphene films can also be used in the present invention.

In more specific embodiments, the carbon source is a polymer. In some embodiments, the polymer can be a hydrophilic polymer, a hydrophobic polymer, or an amphiphilic polymer. In various embodiments, suitable polymers may also include homopolymers, copolymers, polymer blends or polymers with dissolved solutes. Additional suitable polymers may also include thermoplastic polymers, thermosetting polymers, blends of thermoplastic polymers, blends of thermosetting polymers, or blends of a thermoplastic polymer with a thermosetting polymer.

More specific and non-limiting examples of suitable polymers may include, without limitation, poly(2-phenylpropyl)methysiloxane (PPMS), poly(methyl methacrylate) (PMMA), polystyrene (PS), high impact polystyrene (HIPS) which is a co-polymer of styrene and butadiene, acrylonitrile butadiene styrene (ABS), polyacrylonitriles, polycarbonates, poly(phenylene ethynylene)s, cellulose, and combinations thereof. In more specific embodiments, the carbon source is PMMA.

In additional embodiments, the carbon source is a carbon nanotube. Non-limiting examples of carbon nanotubes that can be used as carbon sources include single-walled carbon nanotubes, multi-walled carbon nanotubes, double-walled carbon nanotubes, ultrashort carbon nanotubes, and combinations thereof. In some embodiments, the carbon nanotubes are functionalized. In other embodiments, the carbon nanotubes are in pristine, non-functionalized form.

In additional embodiments, the carbon source may be a non-polymeric carbon source, such as a raw carbon source. Examples of such carbon sources may include, without limitation, carbon derived from food sources (e.g., cookies), carbon derived from organisms (e.g., insects), and carbon derived from waste (e.g., feces and grass). Additional examples and details about the aforementioned raw carbon sources are set forth in Applicants' co-pending Provisional Patent Application No. 61/513,300, filed on Jul. 29, 2011.

In further embodiments, the carbon source may be a gaseous carbon source. In some embodiments, the gaseous carbon source may include, without limitation, methane, ethane, ethene, ethyne, carbon monoxide, carbon dioxide, hydrogen, nitrogen, argon and combinations thereof.

Doped Carbon Sources

In various embodiments, the carbon sources applied onto surfaces may be doped or un-doped. In some embodiments, the carbon sources are un-doped. This results in the formation of pristine graphene films. In additional embodiments, the carbon sources applied to the substrate or catalyst surface is doped with a doping reagent. This results in the formation of doped graphene films.

Various doping reagents may be used in carbon sources. In some embodiments, the doping reagents may be heteroatoms, such as heteroatoms of B, N, O, Al, Au, P, Si, and/or S. In more specific embodiments, the doping reagent may include, without limitation, melamines, boranes, carboranes, aminoboranes, ammonia boranes, phosphines, aluminum hydroxides, silanes, polysilanes, polysiloxanes, phosphites, phosphonates, sulfides, thiols, ammonia, pyridines, phosphazines, borazines, and combinations thereof. In further embodiments, the doping reagents may be HNO₃ or AuCl₃. In some embodiments, HNO₃ or AuCl₃ are sometimes applied after the graphene growth rather than during the growth. In more specific embodiments, the doping reagent is melamine.

In some embodiments, the doping reagent may be added directly to the carbon source. The doping can occur before, during or after the initiation step of graphene formation. For instance, in some embodiments, the doping can occur during the conversion of the carbon source to graphene.

In more specific embodiments, the doping reagent is added to the carbon source as a gas during the conversion of the carbon source to graphene. In such embodiments, the doping reagent may comprise at least one of ammonia, pyridine, phosphazine, borazine, borane, and ammonia borane.

In additional embodiments, the doping may occur after the completion of graphene formation. In some embodiments, the doping reagent may be covalently bound to the carbon source. For instance, a doping reagent may be covalently linked to a polymer's backbone or exogenous additives.

In further embodiments, the carbon source may be a nitrogen-doped carbon source (i.e., N-doped carbon sources). Non-limiting examples of N-doped carbon sources include, without limitation, ABS, acyrylonitrile, and APTES. Such carbon sources can in turn lead to the formation of N-doped graphene films.

The doping reagents of the present invention can have various forms. For instance, in various embodiments, the doping reagents could be in gaseous, solid or liquid phases. In addition, the doping reagents could be one reagent or a combination of different reagents. Moreover, various doping reagent concentrations may be used. For instance, in some embodiments, the final concentration of the doping reagent in the carbon source could be from about 0% to about 25%.

Applying Carbon Sources to Surfaces

Various methods may be used to apply carbon sources to non-catalyst surfaces. In some embodiments, carbon sources are applied directly onto a non-catalyst surface. In such embodiments, the carbon source can form a film or layer directly on the surface. See, e.g., FIG. 1A. In some embodiments, carbon sources are applied onto a surface after a catalyst is applied onto the surface. In such embodiments, the carbon source can form a film or layer on the catalyst that is directly on the surface. See, e.g., FIG. 1B. In some embodiments, carbon sources and catalysts are applied onto a surface at approximately the same time. As also illustrated in FIGS. 1A-1B, any of the aforementioned embodiments can form a bilayer of graphene directly above the surface and below the catalyst.

Various methods may also be used to apply carbon sources to non-catalyst surfaces. For instance, in some embodiments, the carbon source is applied to a substrate or a catalyst surface by a process such as thermal evaporation, spin-coating, spray coating, dip coating, drop casting, doctor-blading, inkjet printing, gravure printing, screen printing, chemical vapor deposition (CVD), and combinations thereof.

In more specific embodiments, various methods may also be used to apply self-assembly carbon sources to a non-catalyst surface. In some embodiments, such methods involve the application of a self-assembling carbon source on top of a non-catalyst surface followed by the application of a catalyst on top of the carbon source. In other embodiments, the methods may involve the application of a catalyst on top of a non-catalyst surface followed by the application of the self-assembling carbon source on top of the catalyst.

The carbon sources may also be applied to various surfaces to form carbon layers of various thicknesses. For instance, the carbon source may form a carbon layer that has a thickness from about 1 nm to about 20 nm. The thickness of the carbon layer may in turn dictate the thickness of the formed graphene films. For instance, in some embodiments, PPMS may be applied to an insulating substrate to form a carbon feedstock layer that is 4-nm thick. This layer may in turn form into a 4 nm thick graphene film.

Catalysts

In the present invention, catalysts generally refer to compositions that are capable of converting carbon sources to graphene films. In some embodiments, the catalyst is a metal catalyst. Non-limiting examples of metal catalysts include Ni, Co, Fe, Pt, Au, Al, Cr, Cu, Mg, Mn, Mo, Rh, Si, Ta, Ti, W, U, V, Zr and combinations thereof. In more specific embodiments, the metallic atoms in the metal catalyst may be in reduced or oxidized forms. In further embodiments, the metal(s) in the metal catalyst may be associated with alloys. In more specific embodiments, the metal catalyst is Ni.

Applying Catalysts to Surfaces

Various methods may be used to apply catalysts to surfaces. For instance, in various embodiments, catalysts are applied to surfaces by at least one of thermal evaporation, electron beam evaporation, sputtering, film pressing, film rolling, printing, ink jet printing, gravure printing, compression, vacuum compression, and combinations thereof. In more specific embodiments, a Ni film may be deposited onto a carbon source by inkjet printing.

In some embodiments, the catalyst can form a film or layer directly on a surface. See, e.g., FIG. 1B. In some embodiments, the catalyst can form a film or layer on a carbon source that is directly on a surface. See, e.g., FIG. 1A. In some embodiments, the catalyst layer can also be patterned atop a carbon source layer. In some embodiments, the patterning can occur by using a mask of direct writing or a printing process.

Graphene Film Formation

Various methods may be used to form graphene films on a non-catalyst surface that contains an applied catalyst and carbon source. For instance, in some embodiments, graphene film formation may be initiated by a heating step, such as induction heating. In some embodiments, the induction heating may utilize various energy sources. Exemplary energy sources include, without limitation, laser, infrared rays, microwave radiation, high energy X-ray heating, and combinations thereof. In some embodiments, the utilization of laser as an energy source for graphene film formation could be particularly advantageous for forming desired patterns of graphene.

Graphene film formation may also occur under various temperatures. For instance, in some embodiments, graphene films may be formed at a temperature range between about 800° C. and about 1100° C. In more specific embodiments, graphene films are formed at about 1000° C.

In some embodiments, suitable reaction temperatures are attained by elevating the environmental temperature. For instance, a sample containing a carbon source and a catalyst on a surface may be placed in a furnace. The furnace temperature may then be elevated to a desired level (e.g., about 1000° C. in some embodiments).

In other embodiments, suitable reaction temperatures may be attained by moving a sample to a suitable environment. For instance, a sample containing a carbon source on a catalyst surface may be in a furnace column (an example of a furnace column is quartz tube 20 in FIG. 2). Thereafter, the sample may be moved into a “hot zone” of the furnace that has a desirable temperature (e.g., about 1000° C.) (an example of a hot zone is split tube furnace 26 shown in FIG. 2).

Various environmental conditions may also be used to initiate graphene film formation. For instance, in some embodiments, graphene film formation occurs in a closed environment, such as an oven or a furnace (e.g., quartz tube 20 shown in FIG. 2). In more specific embodiments, graphene film formation occurs in an inert environment. A specific example of an inert environment is an environment that contains a stream of a reductive gas, such as a stream of at least one of N₂, H₂ and Ar. In more specific embodiments, graphene film formation occurs in a furnace that contains a stream of an H₂/Ar gas.

Various time periods may also be used to initiate and propagate graphene film formation. For instance, in some embodiments, the heating occurs in a time period ranging from about 0.1 minute to about 10 hours. In more specific embodiments, the heating occurs in a time period ranging from about 1 minute to about 60 minutes. In more specific embodiments, the heating occurs for about 10 minutes.

Graphene film formation can also occur under various pressures. In some embodiments, such pressure ranges can be from about 10⁻⁶ mm Hg to about 10 atmospheres. In more specific and preferred embodiments, pressure ranges can be form about 1 mm Hg to about 1 atmosphere. In more specific embodiments, the pressure range may be from about 10 Torr to about 50 Torr. In further embodiments, the pressure range can be from about 6 Torr to about 10 Torr.

Various apparatus may also be used to grow graphene films in accordance with the above-mentioned methods. A specific example of an apparatus is shown in FIG. 2 as apparatus 10. An operation of apparatus 10 was previously described. Other suitable apparatus may also be used to grow graphene films. In some embodiments, such apparatus are metallic chambers or continuous flow furnaces.

Control of Graphene Film Quality

The methods of the present invention can also be used to form graphene films with desired thicknesses, sizes, patterns, and properties. For instance, the methods of the present invention can be used to form monolayer graphene, bilayer graphene, few-layer graphene, multilayer graphene, and mixtures thereof. In some embodiments, the formed graphene is a bilayer.

In some embodiments, the graphene film layer has a bandgap greater than 0 eV and less than 1 eV. With suitable bandgaps (i.e., between 0 eV and 1 eV), graphene films of the present invention can have wide applications in electronics and optics, such as use in room-temperature transistors, electrical and optical sensors, and optoelectronic devices for generating, amplifying, and detecting infrared light.

In some embodiments where there are multiple graphene film layers, there may be a Bernal arrangement between the graphene sheets. A Bernal arrangement generally refers to an AB-stacking arrangement where the bottom layer carbon atoms fit precisely below the holes of the top layer carbon atoms. Graphenes with Bernal arrangement generally have the largest bandgap or tunable bandgap of bilayer graphene. With a Bernal arrangement, graphene can be used for tunnel field-effect transistors and tunable laser diodes.

In other embodiments where there are multiple graphene film layers, there may be a non-Bernal arrangement between the graphene sheets. In some embodiments, the non-Bernal graphene may demonstrate angle-dependent electronic properties.

In further embodiments, the width and length of a surface can be adjusted to yield graphene films with the corresponding widths and lengths. Likewise, in some embodiments, the pattern of a surface can be adjusted to yield a graphene film with the corresponding pattern. In more specific embodiments, a heat source may selectively heat a surface containing a carbon source and a catalysts at selected sites to form a graphene film at those sites. In such embodiments, ribbons or wire-like strips of graphene could be grown, for example. In other embodiments, a laser source could be used in order to form desired patterns of graphene.

Various methods may also be used to control the thickness of the graphene film. For instance, the thickness of graphene films in various embodiments can be controlled by adjusting various conditions during graphene film formation. Such adjustable conditions include, without limitation: (1) carbon source type; (2) carbon source concentration; (3) carbon source thickness on a desired surface; (4) gas flow rate (e.g., H₂/Ar flow rate); (5) pressure; (6) temperature; (7) surface type; (8) placement or deposition of the carbon source relative to the catalyst and the surface; (9) thickness and type of metal catalyst; (10) growth time; and (11) rate of cooling of the formed graphene (i.e., cooling rate).

For instance, in some embodiments, the thickness of the carbon source layer on a surface can be adjusted to correspond to the desired graphene film thickness. In some embodiments, the thickness of the carbon source layer can be adjusted to between about 1 nm to about 10 nm to lead to the formation of graphene films with the corresponding thicknesses.

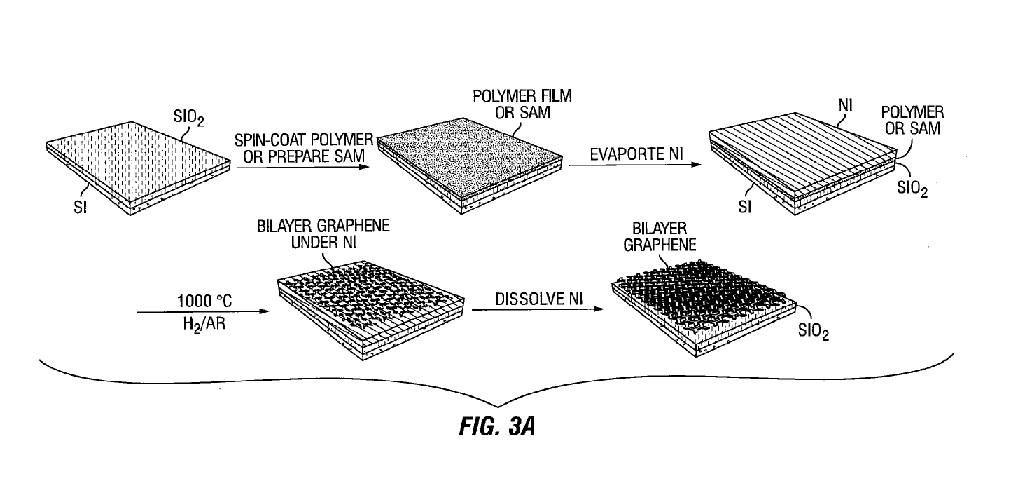

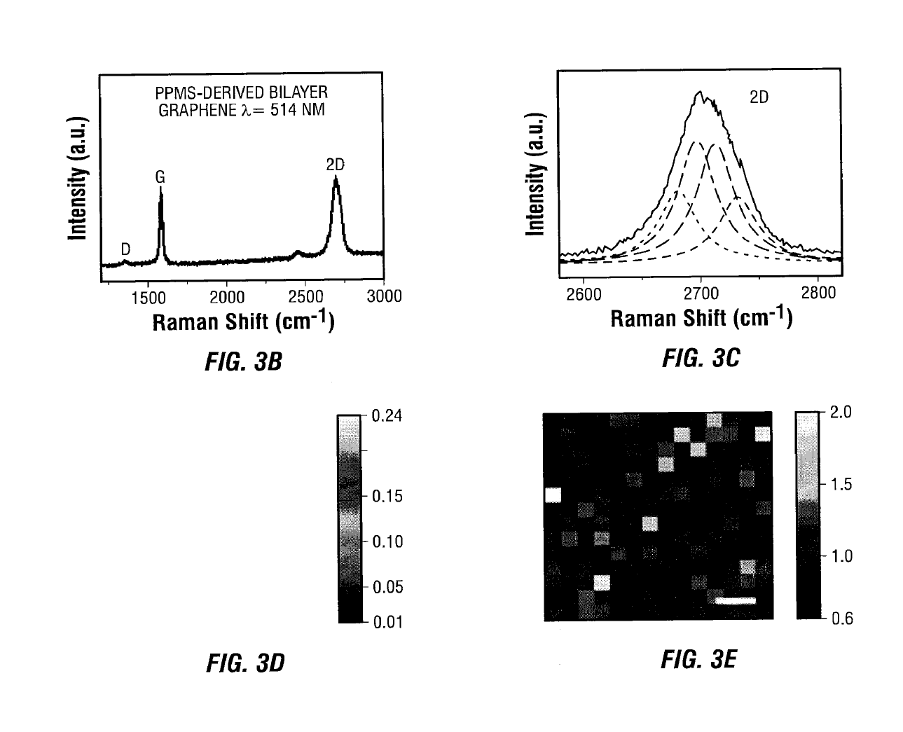

In additional embodiments, the thickness of the formed graphene film can range from about 0.6 nm to about 10 μm. In some embodiments, the thickness of the graphene film is from about 0.5 nm to about 20 nm. In some embodiments, the formed graphene film is a monolayer with a thickness of about 0.35 nm. In other embodiments, the formed graphene film is a bilayer with a thickness of about 0.7 nm. See, e.g., FIG. 3A.

Catalyst Removal

In some embodiments, the methods of the present invention also include a step of separating the catalyst from the formed graphene film on a surface. For instance, in some embodiments, the separating step may be accomplished by acid etching. See, e.g., FIG. 1B. In more specific embodiments, a marble's reagent (e.g., CuSO₄:HCl:H₂O: 10 g:50 mL:50 mL) may be used for acid etching. In other embodiments, the metal can be removed by continued heating at 800° C. to 1200° C. In additional embodiments, a flow of one or more acid gases, such as Cl₂ or other acid gases, could be used to etch a catalyst from a surface. In other embodiments various solutions such as FeCl₃, HCl, and Fe(NO₃)₃ could be used as an etchant to remove a catalyst from a surface. In some embodiments, a catalyst could also be removed from a surface by evaporation or dissolution in water.

Advantages

The methods of the present invention present numerous advantages. For instance, the methods of the present invention can provide homogenous graphene films with uniform thicknesses that are grown directly over a large surface area without the need for a graphene film transfer step. For instance, in some embodiments, graphene films with surface areas in the centimeter ranges can be grown directly on a desired surface, such as an insulating substrate. In some embodiments, the methods of the present invention can form bilayer graphene films that can cover up to 90% to 95% of a large surface area.

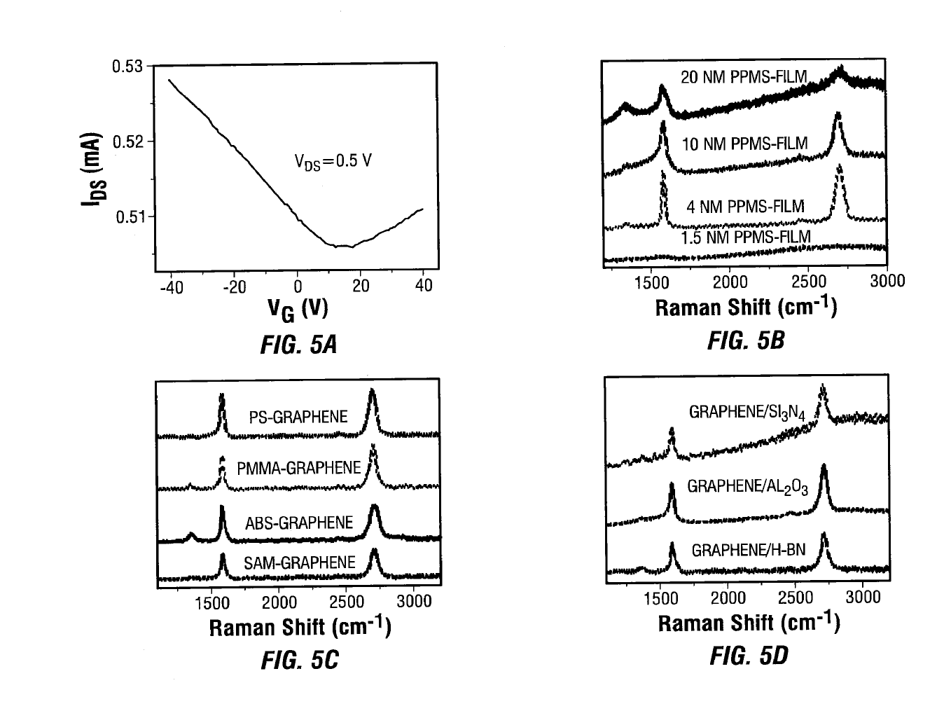

In addition, the graphene films made by the methods of the present invention can have numerous advantageous properties. For instance, as discussed in more detail in the Examples below, the graphene films of the present invention can have a low sheet resistance (e.g., about 2000 Ω/sq to about 3000 Ω/sq or about 1000 Ω/sq to about 5000 Ω/sq). As also discussed in more detail below, the formed graphene films of the present invention can show ambipolar behavior. See, e.g., FIG. 5A (discussed in more detail in the Examples below). As also discussed previously, the graphene films of the present invention can have suitable bandgaps (i.e., between 0 eV and 1 eV) and Bernal arrangements.

Applications

The graphene films formed by the methods of the present invention can have numerous applications in various fields. For instance, in some embodiments, the graphene films formed by the methods of the present invention can be used as electrodes for optoelectronics applications, such as organic photovoltaics, organic light emitting devices, liquid crystal display devices, touch screens, “heads-up” displays, goggles, glasses and visors, and smart window panes. In more specific embodiments, the graphene films of the present invention may also find application in flexible solar cells and organic light emitting diodes (OLEDs), tunnel field-effect transistors, tunable laser diodes, electrical and optical sensors, and optoelectronic devices for generating, amplifying, and detecting infrared light.

### Additional Embodiments

Reference will now be made to more specific embodiments of the present disclosure and experimental results that provide support for such embodiments. However, Applicants note that the disclosure below is for exemplary purposes only and is not intended to limit the scope of the claimed invention in any way.

Additional details about the experimental aspects of the above-described studies are discussed in the subsections below. In the Examples below, Applicants demonstrate the growth of bilayer graphene on various surfaces.

### Example 1

### Direct Growth of Bilayer Graphene on Insulating Substrates

Since its first isolation in 2004, graphene has garnered enormous interest because of its promising electronic applications. Bilayer graphene is particularly interesting because it has a tunable bandgap, thereby being more attractive for many electronic and optical device embodiments. For such applications, uniform-thickness and large-size bilayer graphene films on insulating substrates are desirable. However, the present growth methods either need an additional lift-off step to transfer graphene from the metal catalyst surfaces to the insulating substrates, such as in chemical vapor deposition (CVD) and solid carbon source synthesis methods, or they have difficulty yielding uniform bilayer graphene films directly on insulating substrates, as in epitaxial growth methods from SiC.

Here, we demonstrate a general transfer-free method to directly grow large areas of uniform bilayer graphene on insulating substrates (e.g., SiO₂, h-BN, Si₃N₄ and Al₂O₃) from solid carbon sources, such as films of poly(2-phenylpropyl)methysiloxane (PPMS), poly(methyl methacrylate) (PMMA), polystyrene (PS), and poly(acrylonitrile-co-butadiene-co-styrene) (ABS) (the latter leading to N-doped bilayer graphene due to its inherent nitrogen content). The carbon sources can also be prepared from a self-assembly monolayer (SAM) of butyltriethoxysilane atop a SiO₂ layer. The carbon feedstocks were deposited on the insulating substrates and then capped with a layer of nickel. At 1000° C., under low pressure and a reducing atmosphere, the carbon source was transformed into a bilayer graphene film on the insulating substrates. The Ni layer was removed by dissolution affording the bilayer graphene directly on the insulating substrate with no traces of polymer left from a transfer step.

Pristine monolayer graphene is a semimetal and demonstrates zero bandgap electronic structure. Progress has been made in opening the bandgap of graphene, including using special substrates or defining nanoscale graphene ribbons. Another method to modify the bandgap structure of graphene is to periodically replace the carbon atoms in the graphene matrix with heteroatoms, such as nitrogen and boron. Recent discoveries demonstrate that a widely tunable bandgap can be realized in bilayer graphene and bilayer graphene—BN heterostructures, which opens a new door for applications of graphene in electronic and optical devices.

In the present Example, the scheme for direct growth of bilayer graphene on insulating substrates is shown in FIG. 3A. Here, SiO₂ (500 nm)/Si⁺⁺ and PPMS were used as the insulating substrate and the carbon source, respectively. The SiO₂/Si⁺⁺ wafer was cleaned with oxygen-plasma and piranha solution (4:1 sulfuric acid:hydrogen peroxide). Then, a PPMS film (˜4 nm thick) was deposited on the SiO₂ by spin-coating 200 μL of PPMS solution in toluene (0.1 wt %) at 8000 rpm for 2 min. Next, 500-nm Ni film was deposited on top of the PPMS film using a thermal evaporator (Edwards Auto 306). The Ni was used as the metal catalyst for graphene formation.

The apparatus shown in FIG. 2 was then used to grow graphene from PPMS on the SiO₂/Si⁺⁺ substrate. At a temperature of 1,000° C. for 7 to 20 min, with a reductive gas flow (H₂/Ar) and under low pressure conditions (˜7 Torr), a 1-cm² homogeneous bilayer of graphene was synthesized between the insulating substrate and the Ni film. Next, Marble's reagent was used to dissolve the Ni layer. The end result was that bilayer graphene was directly synthesized on the insulating surface, eliminating the transfer process.

In another embodiment, Applicants used a self-assembly monolayer of butyltriethoxysilane as the carbon source instead of PPMS. Using the same substrate, Ni deposition and growth conditions, a bilayer of graphene was also formed in this embodiment.

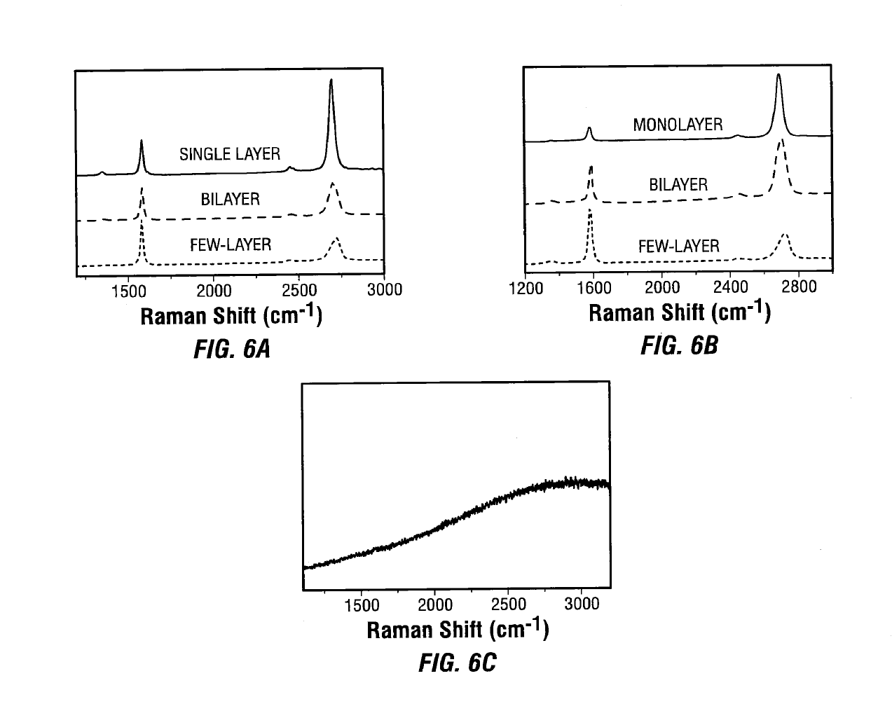

Raman spectroscopy was used to identify the number of layers and to evaluate the quality and uniformity of graphene derived from PPMS on a SiO₂/Si⁺⁺ substrate. FIG. 3B shows the Raman spectrum of the PPMS-derived graphene, which is characteristic of 10 locations recorded over 0.5 cm² of the sample. The two most pronounced peaks in the spectrum are the G peak at ˜1,580 cm⁻¹ and the 2D peak at ˜2,700 cm⁻¹. The full-width-at-half maximum (FWHM) of 2D peak and the I_{G}/I_{2D} peak intensity ratio for bilayer graphene are significantly different from monolayer graphene and few-layer graphene. See FIG. 6A. FIG. 3B also shows that the FWHM of the 2D peak is about 50 cm⁻¹ and the intensities of the G peak and 2D peak are comparable. Furthermore, the 2D peak in FIG. 3B displays an asymmetric lineshape and can be well-fitted by four components with FWHM of 30 to 35 cm⁻¹: 2D_{1B}, 2D_{1A}, 2D_{2A}, and 2D_{2B}. See FIG. 3C (internal peaks, from left to right). This data indicates that the PPMS-derived graphene is indeed bilayered.

The D peak (1,350 cm⁻¹) in FIG. 3B corresponds to defects in the graphene film. However, FIG. 3B shows that the D peak is very low (I_{D}/I_{G}<0.1), indicating few defects in the PPMS-derived graphene. The quality of PPMS-derived graphene over the large area was demonstrated by Raman mappings of the D to G peak ratio. See FIG. 3D. Areas of 112×112 μm² were investigated. In the green and black regions shown in FIG. 3D, the D/G peak ratio is below 0.1, suggesting that high-quality graphene covers ˜95% of the surface.

The quality of PPMS-derived graphene was further confirmed by the low sheet resistance of the graphene film, which is ˜2,000 Ωsq⁻¹ by the four-probe method. The uniformity and the coverage of PPMS-derived bilayer graphene were illustrated by the Raman mappings of the G to 2D peak ratio. See FIG. 3E. Again, an area of 112×112 μm² was investigated and the bilayer region was identified by areas I_{G}/I_{2D} valued at ˜1. The blue region in FIG. 3E is bilayer graphene, suggesting bilayer coverage of ˜90%.

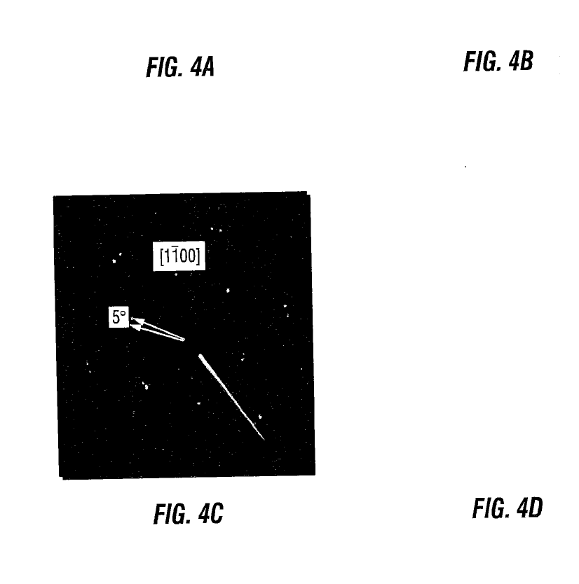

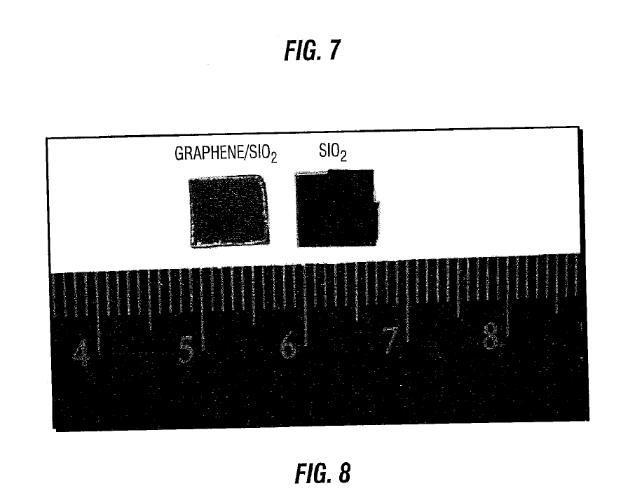

Although the PPMS-derived graphene does not need to be transferred to another substrate in order to be used in most applications, the graphene film was peeled from the SiO₂/Si⁺⁺ substrates using buffered oxide etch (BOE) for transmission electron microscopy (TEM) measurements. TEM images of the pristine PPMS-derived graphene and its diffraction pattern are shown in FIG. 4. The suspended graphene films on the TEM grids are continuous over a large area, as seen under low-resolution TEM. See FIGS. 4A-4B. The selected area electron diffraction (SAED) pattern in FIG. 4C displays the typical hexagonal crystalline structure of graphene. A 5° rotation is found between the two layers, suggesting non-AA or AB-stacked bilayer graphene films. The diffraction analysis shows that most of the area of the bilayer film is non-Bernal (non-AB) stacked graphene. See FIG. 4C. A small portion (3-5%) appears to be Bernal (AB) stacked. See FIG. 7.

The layer count on the edges indicates the thickness of this PMMA-derived graphene. See FIG. 4D. The edge in FIG. 4D is randomly imaged under TEM and most is bilayer graphene, which corroborates the Raman data and further confirms the bilayer nature of this material. FIG. 8 is a photograph of PPMS-derived bilayer graphene synthesized on SiO₂/Si⁺⁺, showing that the graphene film covered the insulating wafer (0.75×0.6 cm²).

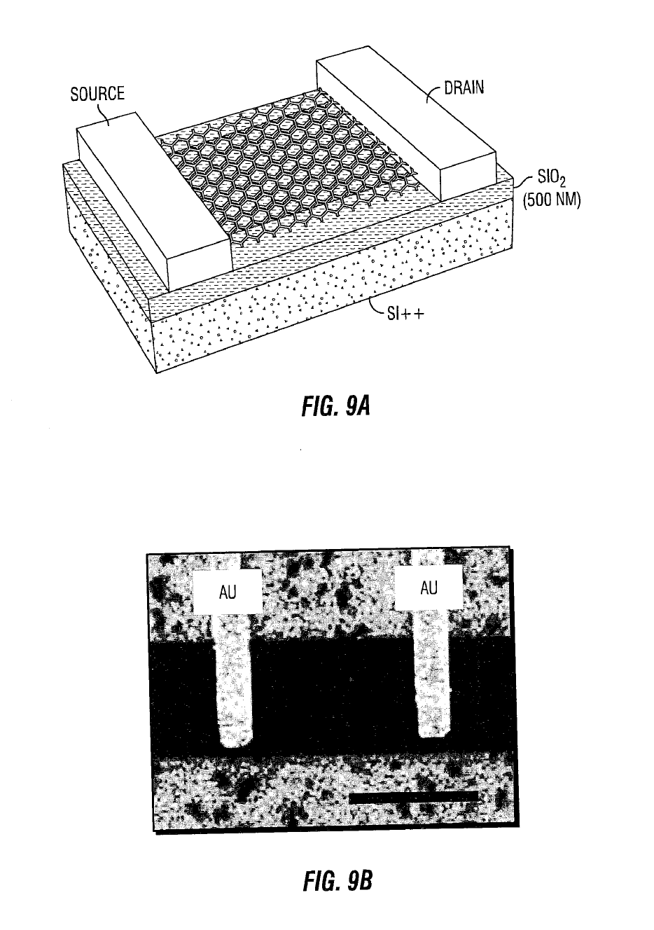

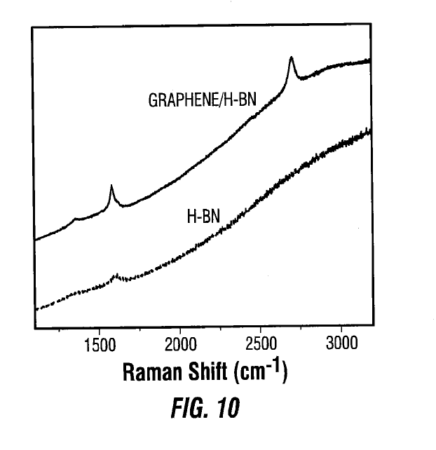

The electrical properties of the obtained graphene were evaluated with back-gated graphene-based field-effect transistor (FET) devices on a 500-nm-thick SiO₂ dielectric. The drain-source current was modulated by applying a back gate voltage. Standard electron-beam lithography and lift-off processes were used to define the source and drain electrodes (30-nm-thick Au) in the graphene devices. Graphene stripes (10 μm wide) were further defined by oxygen-plasma etching. FIGS. 9A and 9B show the schematic and the SEM image of the as-made device. Typical data for the FET devices are shown in FIG. 5A. The PPMS-derived graphene FET shows an ambipolar behavior, which is similar to that of CVD-grown graphene. For this particular device, the carrier (hole) mobility estimated from the slope of the conductivity variation with respect to the gate voltage is ˜220 cm² V⁻¹ s⁻¹ at the room temperature. In the experiments, more than five devices were made, with the mobilities of approximately 220, 180, 150, 130 and 120 cm² V⁻¹ s⁻¹ at room temperature.

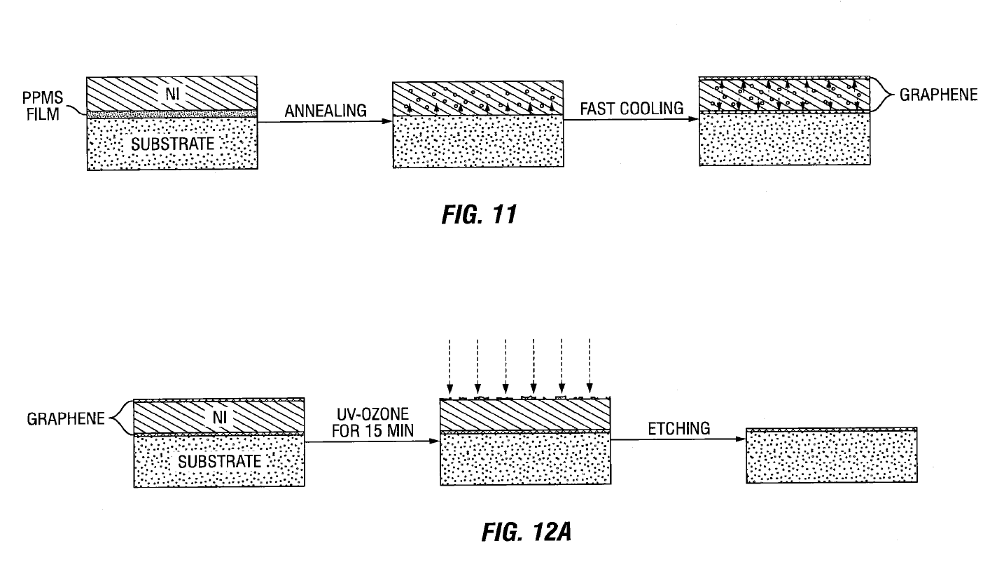

The top Ni surface was analyzed after the reaction and it indeed had its own graphene layer, and it often appeared by Raman analysis to be a bilayer. Hence, it is envisioned that some carbon below the Ni had diffused through the 500-nm-thick Ni film and formed a top graphene bilayer. See FIG. 11.

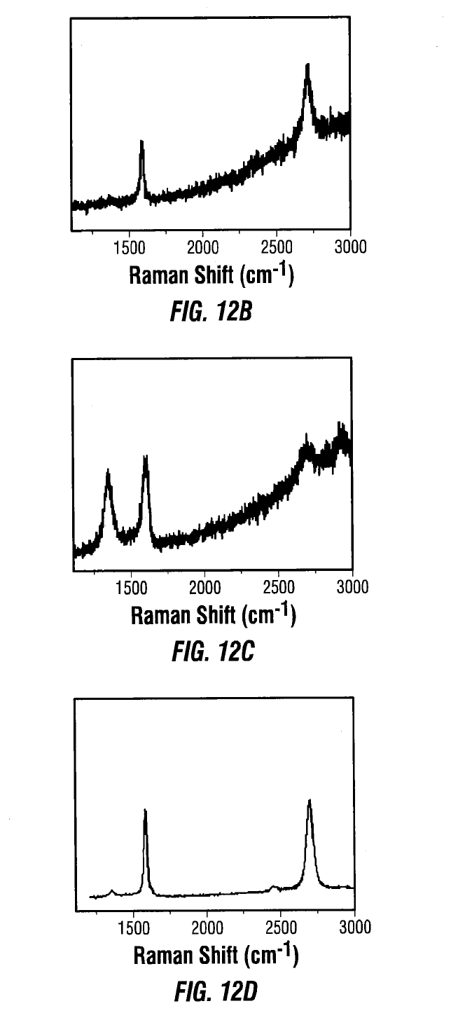

In one case, Applicants treated the top bilayer graphene film with UV-ozone (directed at the top-surface of the Ni), thereby destroying the top-bilayer graphene as verified by Raman analysis. See FIG. 12. After Ni dissolution, the bottom graphene bilayer was pristine. Hence, this excludes the possibility that the graphene on top of the Ni drops to the bottom surface after the Ni dissolution. Thus, the following conclusions can be made from the above experiments: (1) graphene was grown on both sides of the Ni-film due to the diffusion of carbon at the high temperature; and (2) the graphene that formed on the SiO₂/Si⁺⁺ was from the bottom side of the Ni-film. All of the three Raman spectra are characteristic of 10 locations recorded over 0.5 cm² of the samples.

Without being bound by theory, Applicants propose a limited carbon source precipitation process for the growth mechanism of the polymer and SAM-derived bilayer graphene. In the CVD method, the thickness of graphene may be difficult to control when using Ni as the substrate due to the continuous supply of carbon and the high solubility of carbon in Ni. In the present method, the amount of feed carbon is limited and fixed between the insulating substrate and the Ni film at the start of the experiment. The amount of carbon in the 4-nm-thick PPMS film corresponds to ≦20% of the saturated carbon concentration in a 500-nm-thick Ni-film at 1000° C. As illustrated in FIG. 11, the 4-nm-thick PPMS film decomposed and dissolved into the Ni film during the annealing process. When the sample was removed from the hot-zone of the furnace and rapidly cooled, graphene films precipitated from the Ni. The sub-saturated carbon concentration in the Ni film likely facilitates the growth of bilayer graphene rather than few-layer graphene. Bilayer graphene may be obtained instead of monolayer graphene due to the greater thermodynamic stability of bilayers over monolayers.

According to the above proposed mechanism, the amount of carbon in PPMS films will affect the graphene growth. Indeed, we controlled the thicknesses of PPMS films by adjusting the concentrations of PPMS-film-forming solutions. The thicknesses of PPMS films were determined by ellipsometry. A 200 μL sample with a concentration of 0.025, 0.1, 0.5 and 1 wt % of PPMS in toluene yielded thicknesses of approximately 1.5, 4, 10 and 20-nm-PPMS films, respectively, at spin-coat rates of 8,000 rpm. FIG. 5B shows that 4-nm-thick PPMS film was the optimal thickness for the growth of high-quality bilayer graphene. In contrast, when the thickness of PPMS film was 1.5 nm, the amount of carbon in the related PPMS-film was apparently not enough in this experiment for the formation of graphene.

Furthermore, as also shown in FIG. 5B, too much carbon may have caused the growth of multilayer graphene with increased defects. Interestingly, the amount of carbon in 4-nm-thick film of PPMS is very similar to the amount of carbon in four layers of graphene where there is a bilayer below the Ni and an approximate bilayer above the Ni. See FIG. 11. When this amount of carbon is exceeded, multilayers and amorphous carbons are formed. When the amount of carbon is insufficient, discontinuous graphene films may be formed. See FIG. 5B.

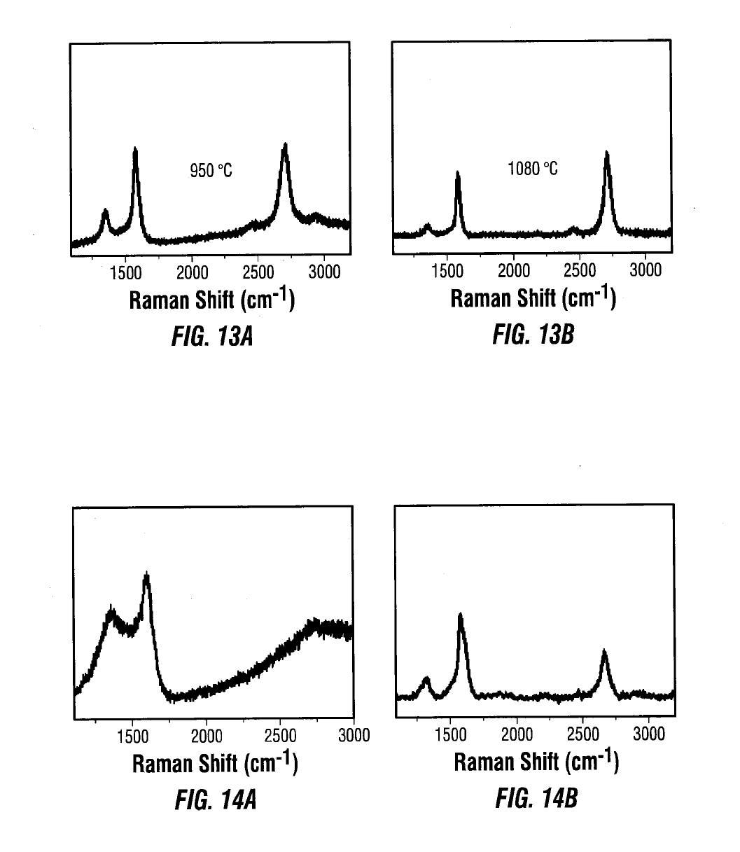

The optimized reaction temperature in this Example was 1000° C. A lower temperature in this Example (950° C.) lead to a larger D-peak in the Raman spectrum, indicating more defects in the obtained graphene. See FIG. 13A. The highest temperature studied was 1080° C., at which bilayer graphene with a low D peak was still obtained. See FIG. 13B.

Applicants also used butyltriethoxysilane (i.e., a SAM) as a carbon source to form graphene on SiO₂. FIG. 5C shows that the SAM was successfully transformed into bilayer graphene. In addition, the sheet resistance was similar to that of PPMS-derived graphene at 2,000 Ωsq⁻¹.

Copper was also used as the catalyst for the direct growth of graphene on insulating substrates. The Raman spectra in FIGS. 14A-14B show that copper transformed a 4-nm-thick PPMS film into amorphous carbon while the SAM was transformed into multilayer graphene with a large D peak. Without being bound by theory, it is envisioned that the growth of graphene on Cu is due to surface catalysis rather than precipitation of carbon from the bulk metal as occurs in Ni.

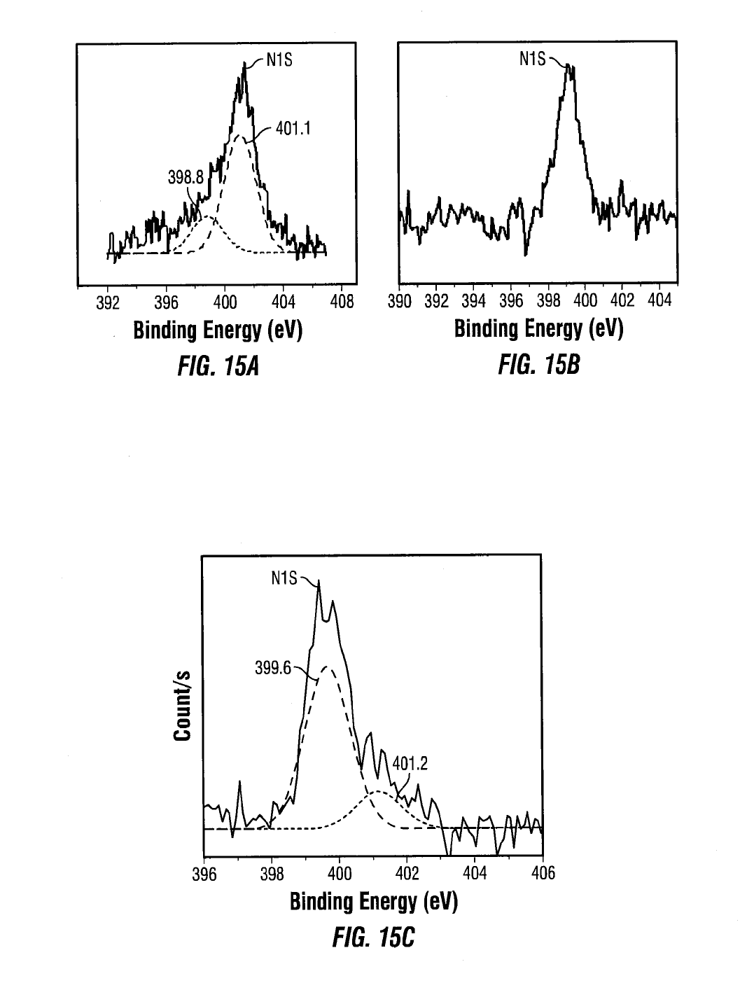

Other polymers (i.e., PS, PMMA and ABS) were also used as carbon sources for the direct growth of graphene on insulating substrates. In these experiments, Applicants selected SiO₂/Si⁺⁺ (500 nm SiO₂) as the substrate. The reaction conditions were the same as those used for the PPMS-derived graphene. The Raman spectra in FIG. 5C indicated that all of these carbon sources were transformed into bilayer graphene when their thicknesses were fixed at ˜4 nm. For PMMA and ABS, the Raman spectra of the obtained graphene showed slightly larger D peaks. In ABS, where N-doped bilayer graphene is obtained, a larger D peak is expected due to the broken lattice symmetry. The sheet resistance for PMMA-derived graphene was ˜3,000 Ωsq⁻¹ and the sheet resistance for ABS-derived graphene was ˜5,000 Ωsq. The X-ray photoemission spectroscopy (XPS) characterization of ABS-derived graphene demonstrates that ABS films were converted into N-doped graphene, with an N content of 2%. See FIG. 15. For PS-derived graphene, the low-D peak demonstrates the high quality of the obtained graphene film. Its sheet resistance is ˜2,000 Ωsq⁻¹, similar to that of the PPMS-derived graphene. Without being bound by theory, this can be further understood in that PS only contains carbon and hydrogen.

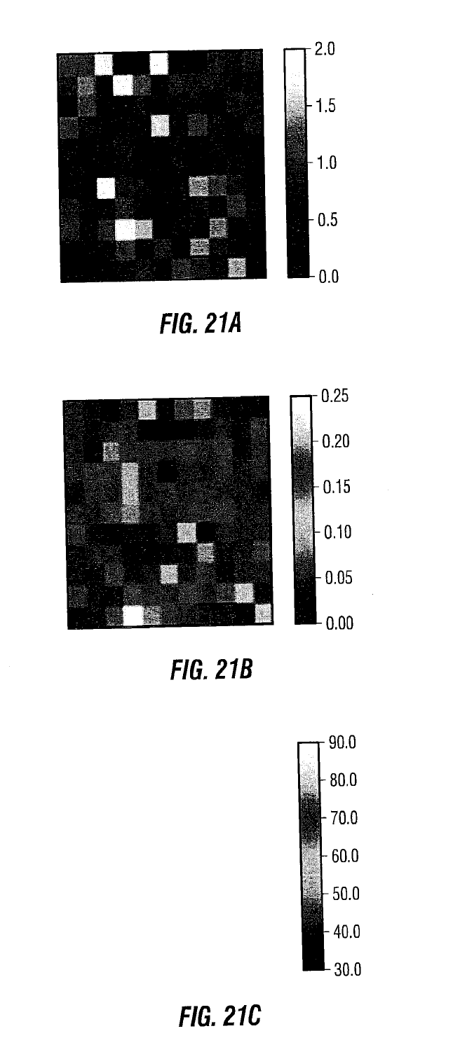

Using similar conditions, Applicants also obtained bilayer graphene from high impact polystyrene (HIPS). See FIG. 21. Using similar conditions, bilayer graphene was also synthesized on several other insulating substrates. The conditions were kept the same as those used for graphene growth on SiO₂ substrates except for replacing the insulating substrates with hexagonal boron nitride (h-BN), Si₃N₄ or Al₂O₃ (sapphire). Large area h-BN was synthesized by CVD of ammonia borane on copper and then transferred onto the SiO₂/Si. After annealing Ni/PPMS/h-BN/SiO₂/Si at 1000° C. for 15 min and dissolving Ni, Raman spectra of the film had G peak and 2D peak signals with comparable intensities, demonstrating the successful synthesis of bilayer graphene on h-BN. See FIG. 5D. While pure h-BN is non-conductive, the sheet resistance of the obtained graphene/h-BN hybrid film was ˜2,000 Ωsq⁻¹, as measured by the four-probe method. Graphene films were also synthesized on Si₃N₄ or Al₂O₃, as shown in FIG. 5D. The sheet resistances of the graphene films on these substrates were both ˜2,000 Ωsq⁻¹.

In conclusion, Applicants have developed a general route for the direct synthesis of large-size and homogeneous bilayer graphene on various insulating substrates. This method is a new controllable transfer-free route that opens the pathway for scalable bilayer graphene growth with direct compatibility to device construction.

### Example 1.1

### Methods Summary

The Ni film was deposited via an Edwards Auto 306 Thermal Evaporator. Raman spectroscopy was performed with a Renishaw RE02 Raman microscope using 514-nm laser excitation at room temperature. A 2100F field emission gun transmission electron microscope was used to take the high-resolution TEM images of graphene samples transferred onto a lacey carbon (Ted Pella) or a C-flat TEM grid (Protochips). Electrical characterizations were performed using an Agilent 4155C semiconductor parameter analyzer at room temperature at 10⁶ Torr. XPS was performed on a PHI Quantera SXM scanning X-ray microprobe with 100 □m beam size and 45° takeoff angle. The thickness of SAMs was determined using an LSE Stokes ellipsometer with a He—Ne laser light source at a λ of 632.8 nm of an angle of incidence of 70°.

### Example 1.2

### Cleaning of Insulating Substrates

Prior to coating the insulating substrates with the solid carbon sources, the SiO₂ underwent a surface cleaning by oxygen-plasma etching for 10 min, followed by immersion in piranha solution (4:1 sulfuric acid:hydrogen peroxide) at 95° C. for 30 min. The substrates were placed in DI water and sonicated (Fisher Scientific FS110H) for more than 60 min. The SiO₂ surfaces were thoroughly rinsed with DI water and were dried by a nitrogen flow. The substrates were further dried in a vacuum oven (˜100 Torr) at 80° C. for 30 min. The h-BN substrates were made by transferring CVD-grown h-BN layers to cleaned SiO₂/Si. Before spin-coating the polymer film, h-BN/SiO₂/Si substrates were annealed for 60 min at 400° C. with H₂ (50 sccm)/Ar (500 sccm) and reduced pressure (˜7.0 Torr). A 500-nm-layer of Si₃N₄ was grown on SiO₂/Si⁺⁺ substrates having a 500-nm-thick SiO₂ layer using plasma-enhanced chemical vapor deposition (PECVD). Both Si₃N₄ and sapphire were cleaned using the above procedure before coating with the carbon sources.

### Example 1.3

### PPMS Preparation

The PPMS solution was made by dissolving PPMS (0.01 g, Gelest, Inc., 1000 cSt) in anhydrous toluene (11.54 mL). The PPMS film was formed by spin-coating 200 μL of the 0.1 wt % solution of PPMS in toluene at 8000 rpm for 2 min. The thickness of the PPMS-film was ˜4 nm as measured by ellipsometry after placing the sample in a high vacuum (2×10⁻⁶ Torr) for 1 h.

### Example 1.4

### PMMA Film Preparation

The PMMA solution was made by mixing PMMA (1 mL, MicroChem Corp. 950 PMMA A4, 4% in anisole) and anhydrous anisole (39 mL). The PPMA film was formed by spin-coating 200 μL of the PMMA solution at 8000 rpm for 2 min. The thickness of PMMA film was ˜5 nm as measured by ellipsometry after placing the sample in high vacuum (2×10⁻⁶ Torr) for 1 h.

### Example 1.5

### PS Film Preparation

The PS solution was made by dissolving PS (0.01 g, Sigma-Aldrich Corporation, average M_{w} ca. 280,000) in anhydrous toluene (11.54 mL). The PS film was formed by spin-coating 200 μL of the 0.1 wt % solution of PS in toluene at 8000 rpm for 2 min. The thickness of the PS film was ˜6 nm as measured by ellipsometry after placing the sample in high vacuum (2×10⁻⁶ Torr) for 1 h.

### Example 1.6

### ABS Film Preparation

The ABS solution was made by dissolving ABS (0.01 g, PolyOne, PD1090 60, LOT #VE0601QD32) in tetrahydrofuran (11.24 mL, THF). The ABS film was formed by spin-coating 200 μL of the 0.1 wt % solution of ABS in THF at 8000 rpm for 2 min. The thickness of the ABS film was ˜5 nm as measured by ellipsometry after placing the sample in high vacuum (2×10⁻⁶ Torr) for 1 h.

### Example 1.7

### SAM Formation

A glass container filled with ˜0.2 mL of butyltriethoxysilane was placed inside a 65 mL vessel. The cleaned SiO₂/Si substrates were places in the interior space between the outer wall of the container with the butyltriethoxysilane and the inner wall of the 65 mL vessel. The 65 mL vessel was sealed with a cap and heated in an oven at 120° C. for ˜7 min. After removing the 65 mL vessel from the oven and allowing it to cool, the substrates were placed in anhydrous toluene and sonicated for 5 min to remove physisorbed butyltriethoxysilane. The substrates were washed with anhydrous toluene followed by methanol and DI water. The substrates were dried by a flow of nitrogen. The measured thickness of the SAM by ellipsometry was ˜0.8 nm, suggesting an approximate bilayer.

### Example 1.8

### Measuring the Thickness of the Carbon Film

An LSE Stokes Ellipsometer was used to measure the thickness of the carbon films. For each specimen, more than ten different spots were measured and the average value was recorded. Prior to the coating of carbon films, the thickness of the native oxide of each sample of the Si substrate was measured using the refractive index of Si (3.875) and SiO₂ (1.465). Approximating that carbon films and the native oxide have the same refractive index of 1.465 (ref 3-6), the thicknesses of carbon films were calculated by subtracting the thickness of the native oxide layer from the total thickness of carbon films and the native oxide.

### Example 1.9

### Ni Film Deposition

An Edwards Auto 306 Thermal Evaporator was used to deposit the Ni film on the top of the carbon film. Nickel powder (low carbon, Puratronic, 99.999%, C<100 ppm) was used as the nickel source and was loaded into an Al₂O₃ boat. The insulating substrates to be coated with the carbon film were fixed on the ceiling of the chamber. The deposition chamber was evacuated for about 60 min until the pressure was ˜1×10⁻⁶ Torr. A 500-nm-Ni-film was deposited at the rate of 0.3 to 0.8 nm s⁻¹. Highly pure Ni was important for the successful synthesis of bilayer graphene. If 99.98% Ni was used as the catalyst in these experiments, few-layer graphene was obtained.

### Example 1.10

### Growth of Bilayer Graphene on Insulating Substrates

The process flow diagram for the graphene growth is shown in FIG. 2. A typical process was as follows. Evacuate a standard 1-inch quartz tube furnace to ˜50 mTorr and maintain the temperature at 1000° C. Start feeding H₂ (20-600 sccm) and Ar (500 sccm), maintaining the total pressure at ˜7 Torr. The sample was placed in a copper enclosure that was used to trap trace O₂ and carbon in the system. The enclosure was formed by bending 25-μm-thick copper foil (Alfa Aesar, 99.98%). Move the sample to the hot region (1000° C.) using a magnetic rod and anneal it for 7 to 20 min. The sample was fast-cooled to room temperature by quickly removing it from the hot-zone of the furnace using the magnetic rod. Both H₂ and Ar were ultrahigh purity (Matheson); M 641-01 (Matheson, Filter 1) was used to purify H₂ and L-500 (Matheson, Filter 2) was used to purify Ar. The mixture of H₂ and Ar was further purified by Filter 3 (Model 6428, Matheson). For SiO₂/Si⁺⁺ insulating substrates, the thickness of the insulating layer should be above 300 nm to prevent Ni from penetrating the insulating layers and reacting with Si. These parameters were optimized and deletion of any part could result in inferior product formation. Rapid cooling of the substrate is essential.

### Example 1.11

### Ni Film Etching

Marble's reagent (CuSO₄:HCl:H₂O in a wt/vol/vol ratio of 10 g:50 mL:50 mL) was used as the etchant. A 100 mL-beaker was filled with 50 mL Marble's reagent. The Ni/graphene/insulating substrates were placed on the bottom of the beaker for 1 min, completely covering the samples with Marble's reagent. The sample was removed from the beaker and the corner of a clean paper towel was used to wick any etchant remained on the substrate. The sample was dipped into a mixture of DI water and ethanol (10 mL:10 mL) for 30 s. It was then dried in the atmosphere. The sample was rinsed with DI water twice and dried by a nitrogen flow.

### Example 1.12

### Peeling Graphene from SiO₂/Si⁺⁺ for TEM Analysis

The process used to remove the graphene from the substrate for TEM analysis was as follows. 200 μL PMMA (MicroChem Corp. 950 PMMA A4, 4% in anisole) solution was deposited on the bilayer graphene/SiO₂/Si⁺⁺ by spin coating at 5000 rpm for 1 min. The obtained sample was cured at 180° C. for 1 min and then dried in a vacuum oven at 70° C. for 2 h to remove the solvent. The sample was then immersed in 7:1 (NH₄F:HF) buffered oxide etch (BOE) overnight. The PMMA/bilayer graphene peeled from the SiO₂/Si⁺⁺ and floated to the surface of the BOE. The graphene was picked up from the BOE using clean glass or SiO₂/Si. The layer was washed with DI wafer twice. The sample was transferred onto a TEM grid for further analysis.

### Example 1.13

### Fabrication Procedure for Graphene FETs

Back-gated graphene-based field-effect transistor (FET) devices were made using PPMS-derived bilayer graphene on SiO₂/Si (500 nm-thick SiO₂). Electron beam lithography was first used to define a PMMA mask on top of the graphene. Reactive ion etching with O₂/Ar flow was used to remove the exposed graphene (flow rate ratio of 1:2 and a total flow rate of 35 sccm). The PMMA mask was dissolved with acetone and then the Ti/Au electrodes were defined by e-beam lithography. 3 nm Ti and 30 nm Au were evaporated using e-beam evaporation.

### Example 1.14

### Calculation of the Amounts of Carbon in the 4-nm-Thick-PPMS-Derived Graphene (and PPMS Film)

Applicants used a two-dimensional unit cell (the dotted dash line in the below picture) to calculate the amount of carbon in the graphene formed on both sides of Ni film.

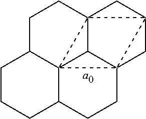

From the carbon-carbon bond length in graphene (L=0.142 nm), one can obtain the unit cell constant a₀ from equation 1:

a₀=2L·cos(30°)=2×0.142×0.866=0.246 nm (1)

Thus, one can calculate the area of the unit cell (S) according to equation 2:

S=a₀²·sin(60°)=0.246²×0.866=0.0524 nm² (2)

Every unit cell contains two carbon atoms. Assuming bilayer graphene was grown on both sides of the Ni, the number of carbon atoms in the graphene over the region of 1 cm² can be calculated from equation 3:

$$n = 4 \times 2 \times \frac{1 {cm}^{2}}{0.0524 {nm}^{2}} = 1.53 \times {10}^{16} \qquad ( 3 )$$

Thus, one can use a similar method to calculate the number of carbon atoms in 4-nm-thick PPMS film over the region of 1 cm². The volume (V) can be determined from equation 4:

V=1 cm²×4 nm=4×10⁻⁷ cm² (4)

For PPMS, the density is 1.02 g/cm³, the weight percentage of carbon is (120/178)=67.4%, and the absolute weight carbon atom is 1.993×10⁻²³ g. Thus, one can calculate the number of carbon atoms in 4-nm-thick PPMS film over the region of 1 cm² using equation 5:

$${n}_{0} = 1.02 \times 4 \times {10}^{- 7} \times 0.674 \times \frac{1}{1.993 \times {10}^{- 13}} = 1.38 \times {10}^{16} \qquad ( 5 )$$

From this approximation, n₀≈n, which means that almost all the carbon atoms from PPMS are transformed into graphene.

### Example 2

### Graphene Formation at Different Growth Temperatures from PMMA

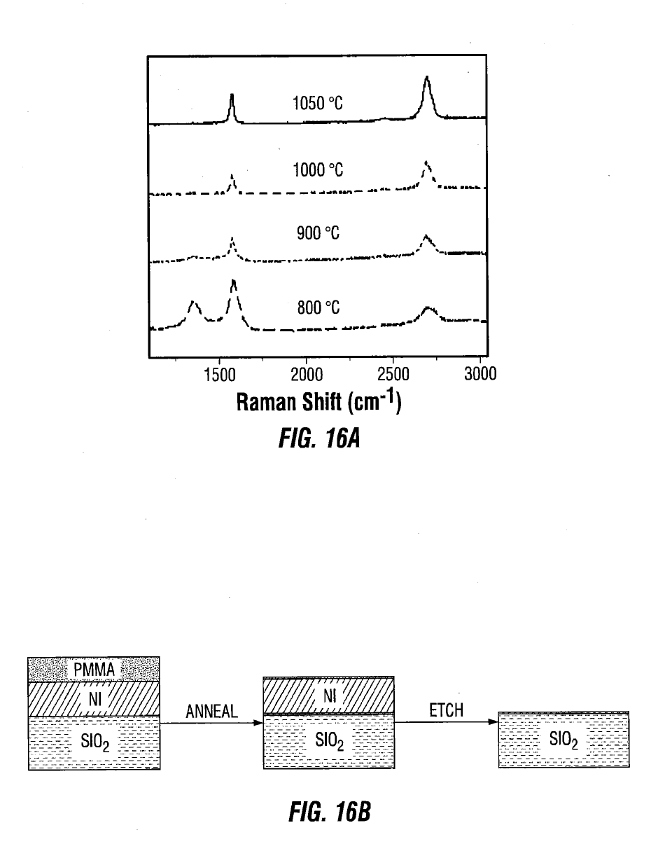

As illustrated in FIG. 16A, Applicants further demonstrated the direct growth of graphene films on insulating substrates at different temperatures ranging from 800° C. to 1050° C. In these experiments, Applicants investigated the effects of the growth temperature on the quality of obtained graphene. In these experiments, PMMA was used as the top carbon source, and SiO₂ was used as the insulating substrate.

The general experimental scheme is illustrated in FIG. 16B. A typical process first involved the evacuation of a standard 1-inch quartz tube furnace to ˜50 mTorr. See Apparatus 10 in FIG. 2. The temperature of the furnace was maintained at the desired growth temperature, which ranged from 800° C. to 1050° C. Streams of H₂ (20-600 sccm) and Ar (500 sccm) were then fed into the furnace while maintaining the total pressure at ˜7 Torr. Next, the sample was placed in a copper enclosure that was used to trap trace O₂ and carbon in the system. The enclosure was formed by bending 25-μm-thick copper foil (Alfa Aesar, 99.98%). The sample was then moved to the hot region (1000° C.) using a magnetic rod. The sample was annealed in the hot region for 7 to 20 min. The sample was then fast-cooled to room temperature by quickly removing it from the hot-zone of the furnace using the magnetic rod.

Both H₂ and Ar were ultrahigh purity (Matheson); M 641-01 (Matheson, Filter 1) was used to purify H₂ and L-500 (Matheson, Filter 2) was used to purify Ar. The mixture of H₂ and Ar was further purified by Filter 3 (Model 6428, Matheson). For SiO₂/Si⁺⁺ insulating substrates, the thickness of the insulating layer was above 300 nm to prevent Ni from penetrating the insulating layers and reacting with Si.

As shown in FIG. 16A, the lower limit for high quality graphene in these experiments is about 900° C. The Raman data analysis demonstrated that a D peak (I_{D}/I_{G}>0.1) appeared when the growth temperature decreased to 900° C.

### Example 3

### N-Doped Graphene Formation from ABS

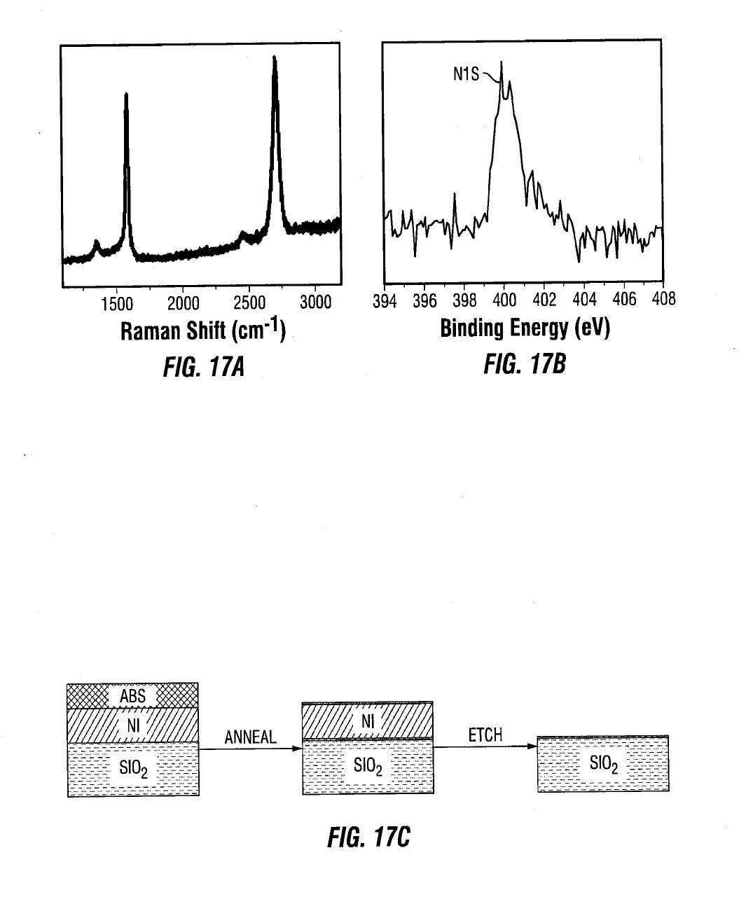

As illustrated in FIG. 17, Applicants have also demonstrated N-doped graphene film formation. As illustrated in FIG. 17C, Ni was first applied to a top surface of an SiO₂ insulating substrate. Next, ABS was applied to the top surface. Graphene film formation was then initiated in accordance with the protocol set forth in Example 2.

As shown in the Raman spectra in FIGS. 17A-B, it was confirmed that there is N-doped graphene forming at (or between) the Ni—SiO₂ interface. Specifically, FIG. 17A shows bilayer graphene was successfully obtained on SiO₂. Likewise, the XPS analysis in FIG. 17B demonstrates that the content of nitrogen in ABS-derived bilayer graphene was around 2.5%.

### Example 4

### Graphene Formation by Chemical Vapor Deposition (CVD)

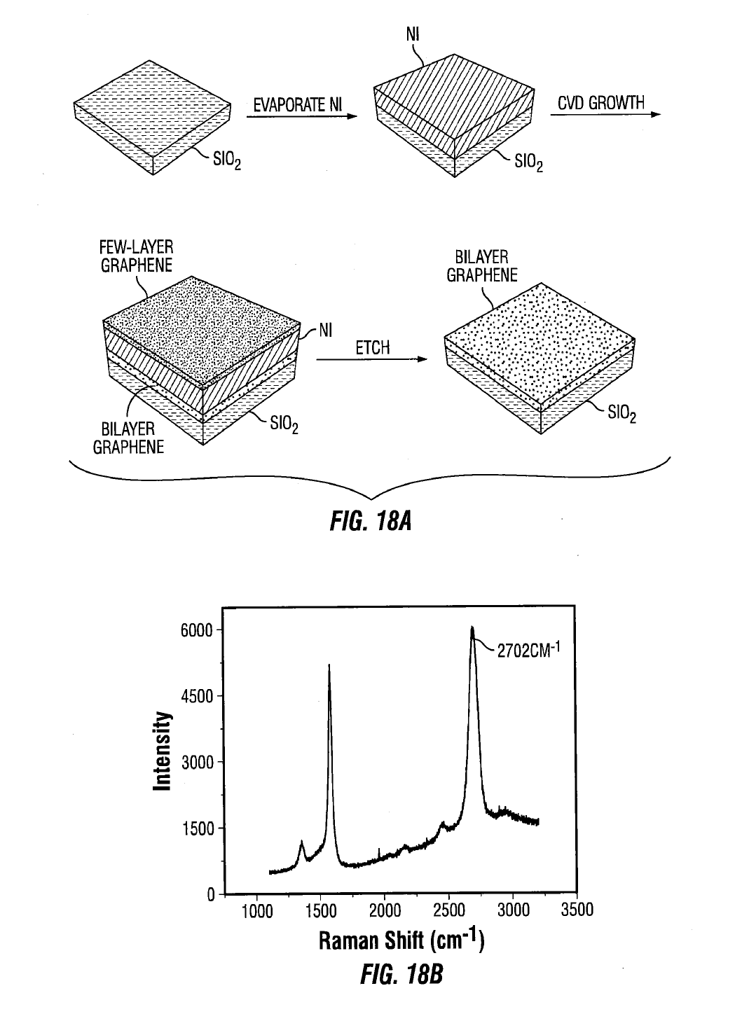

Applicants have also demonstrated graphene film formation on insulating substrates using gaseous carbon sources (such as methane). See FIGS. 18-20. As illustrated in FIG. 18B, Applicants have demonstrated that the deposition of gaseous methane above a metal catalyst (Ni) positioned on an insulating substrate (Si/SiO₂) would diffuse through the metal catalyst to form graphene at the interface between the catalyst and the substrate surface. In particular, the chemical vapor deposition (CVD) method was used on the top Ni surface to make bilayer graphene at (or between) the metal-insulator interface.

A typical process involved the evacuation of a standard 1-inch quartz tube furnace to ˜50 mTorr. See Apparatus 10 in FIG. 2. The temperature was maintained at 1000° C. while H₂ (50-600 sccm) was fed into the furnace and the total pressure was retained at 1 atmosphere. The sample was then moved to the hot region of the furnace (1000° C.) by using a magnetic rod. The sample was annealed for 7 to 20 min. Next, CH₄ (20-100 sccm) was added in as the carbon source for graphene growth for 5 to 30 min. The sample was fast-cooled to room temperature by quickly removing it from the hot-zone of the furnace using the magnetic rod.

H₂ was ultrahigh purity (Matheson); M 641-01 (Matheson, Filter 1) was used to purify H₂. For SiO₂/Si⁺⁺ insulating substrates, the thickness of the insulating layer was above 300 nm to prevent Ni from penetrating the insulating layers and reacting with Si.

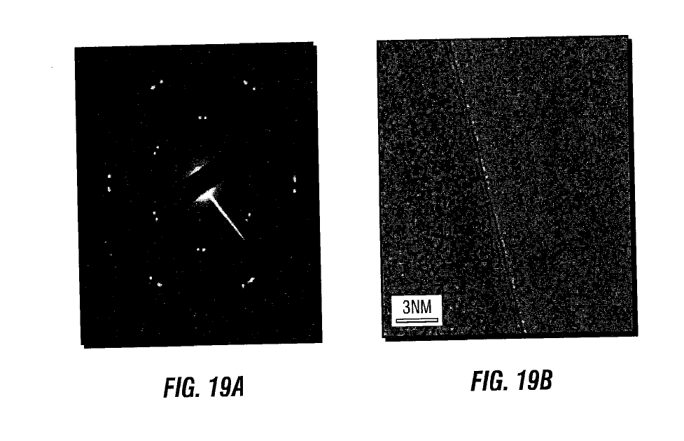

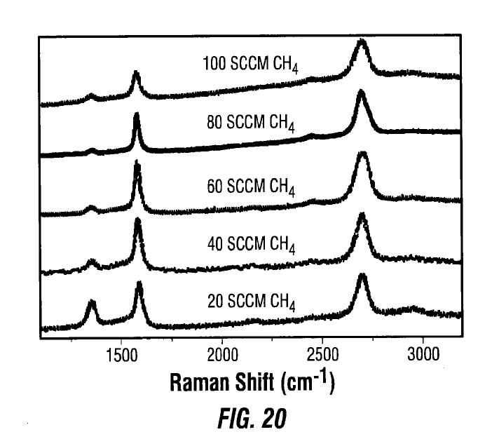

The Raman spectrum in FIG. 18A shows that bilayer graphene was obtained on SiO₂ after etching Ni. TEM analysis confirmed these findings. See FIG. 19. Furthermore, Applicants were able to obtain bilayer graphene at different CH₄ flow rates. See FIG. 20. In these experiments, the bilayer coverage of the substrate surface was around 60%. Applicants could also envision the use of nitrogen-atom containing feed source such as ammonia in methane or pyridine to form doped graphene at (or between) the metal-insulator interface. See Zhong et al., “Large-scale Growth and Characterizations of Nitrogen-doped Monolayer Graphene Sheets,” ACS Nano 2011, 5, 4112-4117.

Without further elaboration, it is believed that one skilled in the art can, using the description herein, utilize the present invention to its fullest extent. The embodiments described herein are to be construed as illustrative and not as constraining the remainder of the disclosure in any way whatsoever. While the preferred embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of growing a graphene film on a non-catalyst surface, wherein the method comprises:
(a) applying a carbon source and a catalyst to the non-catalyst surface; and
(b) initiating the formation of the graphene film from the carbon source on the non-catalyst surface.

2. The method of claim 1, wherein the carbon source is applied to the non-catalyst surface before the catalyst is applied to the surface, and wherein the carbon source forms a layer directly above the non-catalyst surface.

3. The method of claim 1, wherein the catalyst is applied to the non-catalyst surface before the carbon source is applied to the non-catalyst surface, and wherein the catalyst forms a layer directly above the non-catalyst surface.

4. The method of claim 1, wherein the catalyst and the carbon source are applied to the non-catalyst surface at approximately the same time.

5. The method of claim 1, wherein the non-catalyst surface is a non-metal substrate.

6. The method of claim 1, wherein the non-catalyst surface is an insulating substrate.

7. The method of claim 1, wherein the non-catalyst surface is selected from the group consisting of silicon (Si), silicon oxide (SiO₂), SiO₂/Si, silicon nitride (Si₃N₄), hexagonal boron nitride (h-BN), sapphire (Al₂O₃), and combinations thereof.

8. The method of claim 1, wherein the carbon source is selected from the group consisting of polymers, self-assembly carbon monolayers, organic compounds, non-polymeric carbon sources, non-gaseous carbon sources, gaseous carbon sources, and combinations thereof.

9. The method of claim 1, wherein the carbon source is a polymer selected from the group consisting of poly(2-phenylpropyl)methysiloxane (PPMS), poly(methyl methacrylate) (PMMA), polystyrene (PS), acrylonitrile butadiene styrene (ABS), high impact polystyrene (HIPS), polyacrylonitrile and combinations thereof.

10. The method of claim 1, wherein the carbon source comprises a nitrogen-doped carbon source.

11. The method of claim 1, wherein the carbon source is applied to the non-catalyst surface by a process selected from the group consisting of thermal evaporation, spin-coating, spray coating, dip coating, drop casting, doctor-blading, inkjet printing, gravure printing, screen printing, chemical vapor deposition, and combinations thereof.

12. The method of claim 1, wherein the catalyst is a metal catalyst selected from the group consisting of Ni, Co, Fe, Pt, Au, Al, Cr, Cu, Mg, Mn, Mo, Rh, Si, Ta, Ti, W, U, V, Zr and combinations thereof.

13. The method of claim 1, wherein the catalyst is applied to the non-catalyst surface by a process selected from the group consisting of thermal evaporation, electron beam evaporation, sputtering, film pressing, film rolling, printing, ink jet printing, gravure printing, compression, vacuum compression, and combinations thereof.

14. The method of claim 1, wherein initiating graphene film formation comprises induction heating.

15. The method of claim 1, wherein the graphene film is formed in the presence of an inert gas selected from the group consisting of H₂, N₂, Ar and combinations thereof.

16. The method of claim 1, wherein the graphene film is formed at a temperature range between about 800° C. and about 1100° C.

17. The method of claim 1, wherein the formed graphene film is a bilayer.

18. The method of claim 1, further comprising separating the catalyst from the formed graphene film.

19. The method of claim 1, wherein a thickness of the graphene film is controlled by adjusting reaction conditions, wherein the reaction conditions are selected from the group consisting of carbon source type, carbon source concentration, carbon source thickness on the non-catalyst surface, inert gas flow rate, pressure, temperature, reaction time, reaction time at elevated temperatures, non-catalyst surface type, cooling rate and combinations thereof.

20. A method of growing a graphene film on a non-catalyst surface, wherein the method comprises:
(a) applying a carbon source and a metal catalyst to the non-catalyst surface;
(b) initiating the formation of the graphene film from the carbon source on the non-catalyst surface; and
(c) separating the metal catalyst from the formed graphene film.

21. The method of claim 20, wherein the non-catalyst surface is selected from the group consisting of silicon (Si), silicon oxide (SiO₂), silicon nitride (Si₃N₄), hexagonal boron nitride (h-BN), sapphire (Al₂O₃), and combinations thereof.

22. The method of claim 20, wherein the carbon source is selected from the group consisting of polymers, self-assembly carbon monolayers, organic compounds, non-polymeric carbon sources, non-gaseous carbon sources, gaseous carbon sources, and combinations thereof.

23. The method of claim 20, wherein the carbon source is a polymer selected from the group consisting of poly(2-phenylpropyl)methysiloxane (PPMS), poly(methyl methacrylate) (PMMA), polystyrene (PS), acrylonitrile butadiene styrene (ABS), high impact polystyrene (HIPS), polyacrylonitrile and combinations thereof.

24. The method of claim 20, wherein the metal catalyst is selected from the group consisting of Ni, Co, Fe, Pt, Au, Al, Cr, Cu, Mg, Mn, Mo, Rh, Si, Ta, Ti, W, U, V, Zr and combinations thereof.

25. The method of claim 20, wherein initiating graphene film formation comprises induction heating.

26. The method of claim 20, wherein the graphene film is formed in the presence of an inert gas selected from the group consisting of H₂, N₂, Ar, and combinations thereof.

27. The method of claim 20, wherein separating the metal catalyst from the formed graphene film comprises acid etching.

28. The method of claim 20, wherein a thickness of the graphene film is controlled by adjusting reaction conditions, wherein reaction conditions are selected from the group consisting of carbon source type, carbon source concentration, carbon source thickness on the non-catalyst surface, inert gas flow rate, pressure, temperature, reaction time, reaction time at elevated temperatures, non-catalyst surface type, cooling rate and combinations thereof.

29. The method of claim 20, wherein the formed graphene film is a bilayer.
